(19) United States
(12) Patent Application Publication
(10) Pub. No.: US 2026/0062536 A1
(43) Pub. Date: Mar. 5, 2026

(54) COMPOSITIONS AND METHODS FOR ANTIMICROBIAL MATERIALS FOR AUTOMATIC MILKING SYSTEMS AND DAIRY APPLICATIONS

(71) Applicant: The Texas A&M University System, College Station, TX (US)

(72) Inventors: Emily Hunt, Canyon, TX (US); Benton Allen, Amarillo, TX (US); Paige Dodge, Pueblo, CO (US); Trenton Kelly, Canyon, TX (US)

(21) Appl. No.: 19/307,471

(22) Filed: Aug. 22, 2025

Related U.S. Application Data
(60) Provisional application No. 63/687,757, filed on Aug. 27, 2024.

(51) Int. Cl. C08K 3/22; A01J 7/04; C08K 3/08

(52) U.S. Cl. CPC C08K 3/22; A01J 7/04; C08K 2003/0806; C08K 2003/2241; C08K 2003/2296

(57) ABSTRACT

The present disclosure provides for compositions and methods for antimicrobial materials for automatic milking systems and dairy applications. In one aspect, the disclosure relates to composite compositions including an antimicrobial agent and a polymer. A non-limiting example of the disclosed antimicrobial agent is one that includes ZnO, and a non-limiting example of the disclosed polymer is one that includes a silicone polymer. The present disclosure also pertains to methods of making the disclosed composite composition, which in some aspects provides for even distribution of ZnO as disclosed herein. The present disclosure also pertains to methods of abrogating or eliminating mastitis in a dairy herd including using a dairy liner in milking operation including a disclosed composite composition. The present disclosure further pertains to products including the disclosed composite composition. In some aspects, the disclosed products include a dairy liner used in a milking operation.

### CROSS-REFERENCE TO RELATED APPLICATIONS

This application claims benefit of U.S. Provisional Application No. 63/687,757 filed Aug. 27, 2024, which is hereby incorporated herein by reference in its entirety.

### BACKGROUND

Biofilms can play a significant role in the dairy industry: their presence on various stages of production surfaces can have adverse effects on both animal health and milk quality. Notably, biofilm presence can be associated with an increased risk of mastitis in dairy cows. Mastitis infection is the persistent inflammatory reaction of the udder tissue and can be costly to the dairy industry. Biofilm development can occur within the udder, producing infections often impervious to antibiotic treatment and, thereby, difficult to eradicate. Biofilm development is also a common occurrence on surfaces found in the milk extraction system, meaning a primary concern for milking facilities is to control the prevalence of mastitis-associated organisms on surfaces shared between cows during milking operations.

### SUMMARY

The present disclosure relates to the methods, compositions, processes, and products for antimicrobial compositions and molded products. In some aspects, these materials are used in automatic milking systems and dairy applications, as further described in detail herein.

The present disclosure provides for an antimicrobial composition for molded products, which can include an antimicrobial agent embedded in a silicone polymer matrix. In various aspects, the antimicrobial agent can include zinc oxide, titanium dioxide, silver, or combinations thereof. In some aspects, the antimicrobial agent can be about 2% to about 4% of the composition by weight. In some aspects, the antimicrobial agent can be about 3% to about 4% of the composition by weight. In a preferred aspect, the antimicrobial agent can be about 4% of the composition by weight. In various aspects, the antimicrobial agent can be uniformly distributed in the silicone polymer matrix.

In an aspect, the silicone polymer matrix can be an addition-cure silicone polymer. In some aspects, the antimicrobial agent can be zinc oxide. In some aspects, the zinc oxide can be about 2% to about 4% of the composition by weight. In some aspects, the zinc oxide can be about 3% to about 4% of the composition by weight. In a preferred aspect, the zinc oxide can be about 4% of the composition by weight.

The present disclosure also provides for a method for manufacturing an antimicrobial molded product, including mixing an antimicrobial agent and a silicone polymer to form a composite, injecting the composite into a mold such that the composite fills a cavity of the mold, curing the composite such that the composite solidifies, and releasing the composite from the mold. In various aspects, the antimicrobial agent can include zinc oxide, titanium dioxide, silver, or combinations thereof. In some aspects, the antimicrobial agent can be about 2% to about 4% of the composition by weight. In some aspects, the antimicrobial agent can be about 3% to about 4% of the composition by weight. In a preferred aspect, the antimicrobial agent can be about 4% of the composition by weight. In some aspects, the antimicrobial agent can be uniformly distributed in the silicone polymer.

In various aspects, the antimicrobial agent and the silicone polymer can be mixed at least twice for a period of time before injection into the mold. In some aspects, the period of time can be about 1 minute to about 15 minutes. In some aspects, the period of time can be about 1 minute to about 5 minutes. In a preferred aspect, the period of time can be about 2 minutes. In some aspects, the antimicrobial agent and the silicone polymer can be mixed at about 1000 rpm to about 2000 rpm. In some aspects, the antimicrobial agent and the silicone polymer can be mixed at about 1200 rpm to about 1700 rpm. In a preferred aspect, the antimicrobial agent and the silicone polymer can be mixed at about 1500 rpm.

In various aspects, the composite can be cured under a pressure of about 25 psi to about 75 psi. In some aspects, the composite can be cured under a pressure of about 40 psi to about 60 psi. In a preferred aspect, the composite can be cured under a pressure of about 50 psi.

In various aspects, the composite can be injected into the mold using a catheter tip syringe. In various aspects, the silicone polymer can be an addition-cure silicone polymer including a resin and a hardener.

In various aspects, mixing the antimicrobial agent and the silicone polymer to form the composite can further involve adding the antimicrobial agent to the resin and mixing for a first period of time, and adding the hardener to the resin and the antimicrobial agent to form the composite, wherein the composite is mixed for a second period of time. In some aspects, the period of time can be about 1 minute to about 15 minutes. In some aspects, the period of time can be about 1 minute to about 5 minutes. In a preferred aspect, the period of time can be about 2 minutes. In some aspects, the antimicrobial agent and the silicone polymer can be mixed at about 1000 rpm to about 2000 rpm. In some aspects, the antimicrobial agent and the silicone polymer can be mixed at about 1200 rpm to about 1700 rpm. In a preferred aspect, the antimicrobial agent and the silicone polymer can be mixed at about 1500 rpm.

In various aspects, the antimicrobial agent can be zinc oxide. In some aspects, the zinc oxide can be about 2% to about 4% of the composition by weight. In some aspects, the zinc oxide can be about 3% to about 4% of the composition by weight. In a preferred aspect, the zinc oxide can be about 4% of the composition by weight.

The present disclosure also provides for an antimicrobial milking liner made from a composition including an antimicrobial agent embedded in a silicone polymer matrix. In various aspects, the antimicrobial agent can include zinc oxide, titanium dioxide, silver, or combinations thereof. In some aspects, the antimicrobial agent can be about 2% to about 4% of the composition by weight. In some aspects, the antimicrobial agent can be about 3% to about 4% of the composition by weight. In a preferred aspect, the antimicrobial agent can be about 4% of the composition by weight. In various aspects, the antimicrobial agent can be uniformly distributed in the silicone polymer matrix.

In some aspects, the antimicrobial agent of the antimicrobial milking liner made from the composition can be zinc oxide. In some aspects, the zinc oxide can be about 2% to about 4% of the composition by weight. In some aspects, the zinc oxide can be about 3% to about 4% of the composition by weight. In a preferred aspect, the zinc oxide can be about 4% of the composition by weight.

In some aspects, the antimicrobial milking liner can have a thickness of about 1 mm to about 5 mm. In some aspects, the antimicrobial milking liner can have a thickness of about 2 mm to about 4 mm. In a preferred aspect, the antimicrobial milking liner can have a thickness of about 3 mm.

The present disclosure also provides for a method of abrogating or eliminating mastitis in a dairy herd including using an antimicrobial milking liner made from a composite, where the composite includes an antimicrobial agent embedded in a silicone polymer matrix. In some aspects, the antimicrobial agent can include zinc oxide, titanium dioxide, silver, or combinations thereof. In some aspects, the antimicrobial agent can be about 2% to about 4% of the composition by weight. In some aspects, the antimicrobial agent can be about 3% to about 4% of the composition by weight. In a preferred aspect, the antimicrobial agent can be about 4% of the composition by weight. In various aspects, the antimicrobial agent can be uniformly distributed in the silicone polymer matrix.

In some aspects, the silicone polymer matrix can be an addition-cure silicone polymer. In various aspects, the antimicrobial agent can be zinc oxide. In some aspects, the zinc oxide can be about 2% to about 4% of the composition by weight. In some aspects, the zinc oxide can be about 3% to about 4% of the composition by weight. In a preferred aspect, the zinc oxide can be about 4% of the composition by weight.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure.

FIG. 1.1 illustrates polymeric samples for antimicrobial testing including control (A); 2% ZnO additive (B); 4% ZnO additive (C).

FIG. 1.2 illustrates S. aureus ATCC 6538 comparisons of average CFU/mL at 24 hours for control silicone or acrylic samples, or silicone samples with 0%, 2%, or 4% ZnO additive.

FIG. 1.3 illustrates comparative analysis of microbial colonies of sample effluent (plated in duplicate).

FIG. 1.4 illustrates a composite image showing comparative analysis of microbial colonies of raw milk sample effluent (1:104 dilution) for the acrylic control and silicone with 0%, 2%, or 4% ZnO additive.

FIGS. 1.5A-1.5C illustrate analysis of peel plates plated with raw milk sample effluent using ImageJ Particle Analyzer, including heat mapping (FIG. 1.5A), threshold modification (FIG. 1.5B), and Particle Analysis (FIG. 1.5C).

FIG. 1.6 illustrates raw milk overlay comparison of average CFU/mL for control samples, or silicone with 0%, 2%, or 4% ZnO additive.

FIG. 2.1 illustrates a novel technique for uniform distribution of zinc oxide particles in a polymer matrix.

FIG. 2.2 illustrates the hardness testing setup using handheld durometer and steel weight.

FIGS. 2.3A-2.3B illustrate a steel rule cutting die (FIG. 2.3A) and 2-ton arbor press (FIG. 2.3B) used to die-cut samples for uniaxial tensile test.

FIGS. 2.4A-2.4B illustrate the experimental setup for uniaxial tensile test (FIG. 2.4A) and inset of setup showing polymer coupon clamped into the fixture (FIG. 2.4B).

FIG. 2.5 illustrates average shore A hardness for treatments of zinc oxide in a silicone polymer matrix.

FIGS. 2.6A-2.6C illustrate elastic progression of polymer in strain conditions of (FIG. 2.6A) 0%, (FIG. 2.6B) 25%, and (FIG. 2.6C) 50%.

FIG. 2.7 illustrates average Young's Modulus by treatment for silicone with 0%, 1%, 2%, and 4% ZnO.

FIG. 3.1 illustrates an example of a milking liner used in an automated milking apparatus.

FIG. 3.2 illustrates a preliminary experimental setup to develop biofilm on polymer samples in a closed system.

FIG. 3.3 illustrates a secondary experimental setup to develop biofilm on polymer samples in an open system.

FIGS. 3.4A-3.4B illustrate polymer samples prior to swabbing.

FIG. 3.5 illustrates polymer samples removed from the secondary test device and ready for drying.

FIGS. 3.6A-3.6B illustrate Staph. aureus colonies in bulk tank milk samples. Peel Plate SA plates show the growth of Staph. aureus (green colonies) and additional aerobic bacteria (red colonies) in bulk tank milk samples collected from the hospital milking parlor. Each plate represents 1 mL of milk diluted at a ratio of 1:10 in BPBDW, both from identical samples.

FIGS. 3.7A-3.7B illustrates colony forming units present on Peel Plates (104 dilution) for 0% ZnO and 4% ZnO treatments after secondary testing procedure. Presented as raw data (FIG. 3.7A) and as trimmed data (FIG. 3.7B).

### DETAILED DESCRIPTION

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

In describing and claiming the disclosed subject matter, the following terminology will be used in accordance with the definitions set forth below.

Unless otherwise defined, all terms of art, notations and other scientific terminology used herein are intended to have the meanings commonly understood by those of skill in the art to which this disclosure pertains. In some cases, terms with commonly understood meanings are defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art. As appropriate, procedures involving the use of commercially available kits and reagents are generally carried out in accordance with manufacturer defined protocols and/or parameters unless otherwise noted. As used in the specification and the appended claims, the singular forms “a,” “an” and “the” include plural referents unless the context clearly dictates otherwise. Thus, for example, reference to “a antimicrobial agent,” “a dairy liner,” or “a composite composition,” including, but not limited to, to two or more such antimicrobial agents, dairy liners, or composite compositions, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

The terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The following terms have the meanings ascribed to them unless specified otherwise. In this disclosure, “comprises,” “comprising,” “containing” and “having” and the like can have the meaning ascribed to them in U.S. patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. patent law, allowing for the presence of more than that which is recited so long as basic or novel characteristics of that which is recited is not changed by the presence of more than that which is recited, but excludes prior art embodiments.

The term “effective amount” refers to an amount that is sufficient to achieve the desired modification of a physical property of the composition or material. For example, an “effective amount” of an antimicrobial agent, such as ZnO, refers to an amount that is sufficient to achieve the desired improvement in the property modulated by the formulation component, e.g. abrogating or eliminating a biofilm. The specific level in terms of wt % in a composition required as an effective amount will depend upon a variety of factors including the amount and type of polymer with which it is formulated, amount and type of ZnO, and end use of the article made using the disclosed composition.

The term “milking liner” refers to a flexible, durable polymer insert used in conjunction with an automatic milking apparatus to withdraw milk from an animal. A milking liner can also be referred to as a dairy inflation, teat cup liner, or shell liner. The milking liner transfers stimulation from the milking machine to the udder to induce milk flow. The milk passes from the teat through the milking liner into the milk supply line. The milking liner can be the only direct interface between the animal and the milking apparatus.

The terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Discussion

The present disclosure provides for compositions, methods of making, and methods of use of antimicrobial molded products in automatic milking systems and similar dairy applications, as further described in herein below.

The present disclosure pertains to the development of engineered materials incorporating antimicrobial agents into the polymer matrix of molded products, such as dairy liners, to establish a passive defense against pathogenic microbes. As disclosed herein, by incorporating zinc oxide (ZnO), titanium dioxide, silver, and similar antimicrobial agents into a silicone polymer matrix, the disclosed compositions and materials enhance the material's antimicrobial properties without compromising its essential mechanical characteristics.

In an aspect, the disclosure relates to material compositions for molded products comprising an antibacterial agent uniformly distributed in a silicone polymer matrix. A non-limiting example of the disclosed antibacterial agent is one that comprises ZnO; and a non-limiting example of the disclosed polymer is one that comprises a silicone polymer. The present disclosure pertains to integrating antimicrobial agents into a silicone polymer matrix at varying, but non-limiting, concentrations (e.g., 1%, 2%, and 4% w/w). The disclosed materials and compositions combat the microbial colonization or formation of biofilms on molded products without comprising mechanical characteristics such as hardness. The present disclosure provides an efficacious and cost-effective approach to material science applications in agriculture by integrating passive microbial-resistant molded products into agricultural operations.

The present disclosure further pertains to the disclosed method that provides for (a) the even distribution of the antibacterial agent (e.g., ZnO particles) within the polymer matrix, (b) the shaping of the antibacterial-enhanced resin (e.g., ZnO-enhanced resin) into predetermined molded forms, and (c) the production of cured samples devoid of major air inclusions. In aspect, the method comprises mixing an antimicrobial agent and a polymer (e.g., silicone polymer) to form a composite. The antimicrobial agent can include zinc oxide, titanium dioxide, silver, or combinations thereof. In a nonlimiting example, the antimicrobial agent is zinc oxide and the zinc oxide comprises approximately 1 to 4% or approximately 4% of the composite by weight.

The composite is injected into a mold such that the composite fills the cavity of the mold, and is cured such that the composite solidifies. The composite is then released from the mold as the final molded product. In an aspect, the antimicrobial agent and silicone polymer are mixed at 1500 rpm for 2 minutes at least twice before injection into the mold to uniformly distribute the antimicrobial agent. In an aspect, the composite is cured under pressure of about 50 psi until the composite solidifies. In another aspect, the composite is injected into the mold using a catheter tip syringe to reduce the inclusion of air bubbles.

In an aspect, the silicone polymer can be an addition-cure silicone polymer comprising a resin and a hardener. In a non-limiting example, the resin and hardener are mixed at a ratio of 10:1. In an aspect, the antimicrobial agent is first added to the resin and mixed at 1500 rpm for 2 min. The hardener is then added, and the composite is mixed again at 1500 rpm for 2 min.

The present disclosure provides for a milking liner made from a material comprising an antibacterial agent uniformly dispersed in a silicone polymer matrix. In an aspect, the antibacterial agent can zinc oxide, titanium dioxide, silver, or combinations thereof. In an aspect, the composition comprises zinc oxide (ZnO) as an antimicrobial agent when embedded within a polymer matrix resembling those used in commercial dairy liners. In an aspect, the antimicrobial agent comprises about 1-4% of the composition by weight. In an aspect, the milking liner has a thickness of about 3 mm.

The present disclosure also pertains to methods of abrogating or eliminating mastitis in a dairy herd comprising using an antimicrobial milking liner in a dairy operation comprising an antimicrobial agent uniformly distributed in a silicone polymer matrix. Microbial colonization or formation of biofilms on milking liners is a common issue in dairy applications, where such microbial contaminations can lead to infection transmission in dairy farms. In an aspect, an antimicrobial milking liner can be used to reduce the spread of mastitis without resorting to increased antibiotic interventions. By examining the antimicrobial effectiveness of molded products embedded with antimicrobial agents, the present disclosure provides a strategy for reducing reliance on antibiotics in dairy herds, aligning with sustainable agricultural practices.

The present disclosure demonstrates the feasibility of using milk liners as a self-sanitizing interface between animals, milk, and machinery. The antimicrobial compositions and methods disclosed herein provides insights into designing molded products that resist microbial colonization. This effort aligns with broader agricultural and public health objectives by aiming to enhance milk quality, reduce the reliance on antibiotics, and prevent the transmission of pathogenic bacteria among dairy calves—a concern highlighted by the practice of feeding calves with milk from infected animals.

The presence of persistent, unwanted microbiological organisms on production surfaces in the agricultural industry is a costly, problematic, and well-documented phenomenon. From calf hutches to fabrication tables and grain bins to watering troughs, the presence of unwanted microbiological organisms can have detrimental effects throughout the agricultural sector. Microbiological organisms are ubiquitous in the environment or shed from diseased animals and often form biofilms on surfaces of agricultural watering equipment, housing infrastructure, animal health treatment facilities, protein production plants, and dairy operations. Biofilms are matrices of cellular and extracellular material that develop on bacteria-laden surfaces. Once developed, biofilms protect microorganisms from sanitization efforts and support microbiological proliferation throughout the agricultural operation. The total economic cost of biofilms is prodigious. The global economic impact of biofilms on the agriculture and food production sector is estimated at USD 324 billion annually (Cámara et al., 2022). When paired with the swelling prominence of antimicrobial resistance and the rising cost of facility sanitization efforts, there is an increasing interest in the control of biofilms to support agricultural production (Cámara et al., 2022).

Many surfaces in the agricultural sector are made from polymers due to their corrosion resistance, adaptability, mechanical properties, high strength-to-mass ratio, and low cost (Namazi, 2017). However, polymers are inherently susceptible to biofilm formation and premature degradation from microbial processes. The likelihood of surfaces attracting biofilm development is controlled by parameters such as hydrophobicity, stiffness, and surface roughness (Lichter et al., 2009), of which the latter two are highly susceptible to polymer degradation. Once established, biofilms harbor pathogens that negatively impact animal health and welfare and the production efficiency and quality of agricultural products. Biofilms play a significant role in the dairy industry: their presence on various stages of production surfaces can have adverse effects on both animal health and milk quality. Notably, biofilm presence is associated with an increased risk of mastitis in dairy cows.

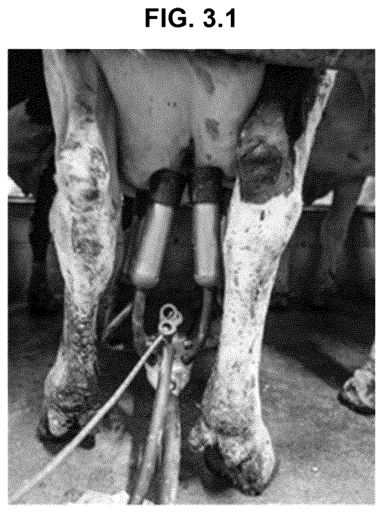

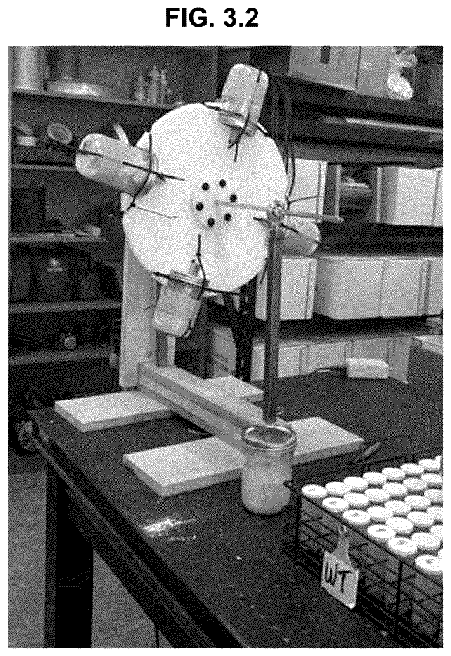

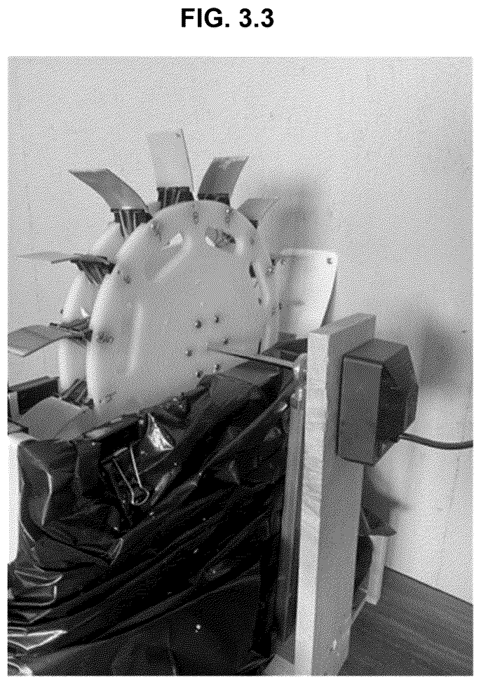

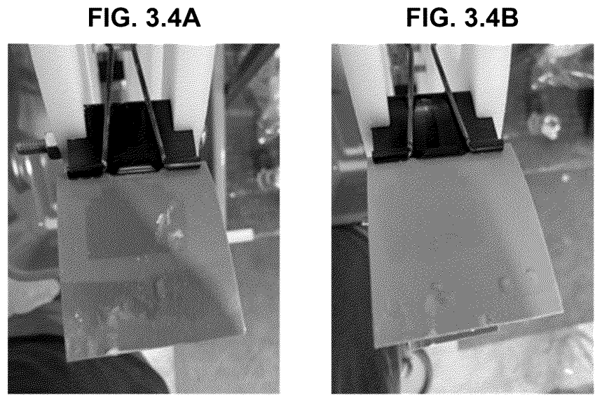

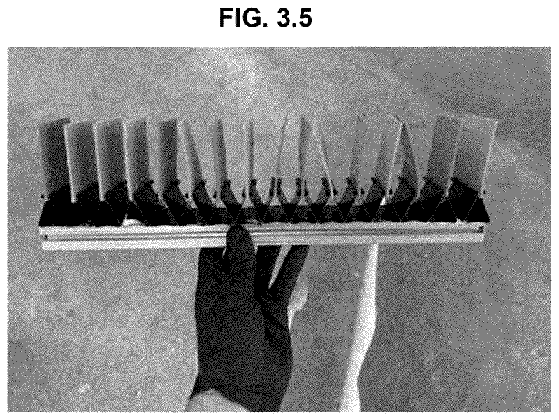

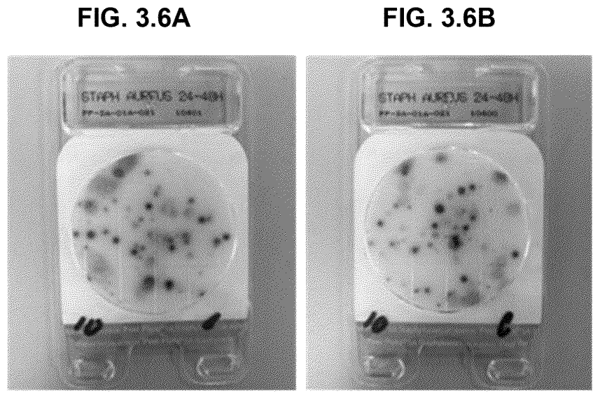

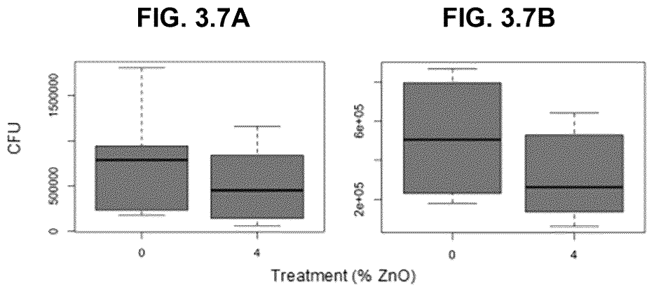

Mastitis infection is the persistent inflammatory reaction of the udder tissue and is the most common disease among dairy cattle (Boireau et al., 2018). With direct and indirect costs of mastitis infections totaling $444 per animal (Rollin et al., 2015), it is also the costliest disease impacting the dairy industry. Biofilm development can occur within the udder, producing infections often impervious to antibiotic treatment and, thereby, difficult to eradicate (Høiby et al., 2011, 2015). Biofilm development is also a common occurrence on surfaces found in the milk extraction system, meaning a primary concern for milking facilities is to control the prevalence of mastitis-associated organisms on surfaces shared between cows during milking operations-principally, the milking liners that pull milk from the bovine udders. Milking liners (dairy inflations, teat cup liners, or shell liners) are flexible, durable polymer inserts used by milking clusters to withdraw milk from the animal (FIG. 3.1).

The liner transfers stimulation from the milking machine to the udder to induce milk flow. It then carries produced milk from the teat into the milk supply line. The milking liner is the only direct interface between the animal and the milking apparatus and is an important area for disease transmission prevention efforts (Rainard et al., 2018). Milk liners are recognized to harbor mastitis-associated microorganisms even after regular, routine sanitization procedures (Latorre et al., 2020).

A typical order of milking operations was observed of a Texas Panhandle area dairy as follows: cows step onto the rotary to have their teats washed with a lactic acid spray from an employee. A second employee simultaneously rinses the milking cluster, the floor of the station, and udders with water. The teats are then cleaned with an udder rag and cleaning solution by a different employee before the milking cups are attached. The cow then travels around the rotary as milking begins. The system monitors the cow's production during milking, and once production ends, the cluster automatically withdraws from the cow. Before exiting the rotary, the udders are sprayed with a post-milking compound to help prevent mastitis. The cows are then sprayed with a flea spray before leaving the barn. Usually, a clean-in-place (CIP) procedure is performed at the end of each day or after each round of milking. In some instances, or if the herd is experiencing a mastitis outbreak, a CIP may be performed for each cluster after each animal.

A typical procedure for CIP in a dairy setting is outlined by Vargová et al. (2023) as: 1) pre-rinse cycle using water; (2) wash cycle using a cleaning regimen that includes active ingredients such as AMP detergent, sodium hydroxide up to 10%, and sodium hypochlorite solution up to a maximum of 90%; and (3) an acid wash cycle using CIP acid cleaner and active ingredients such as detergents, 10% hydrogen peroxide, and 45% trihydrogenphosphoric acid.

However, biofilms are growing increasingly resistant to biocides used in CIP and antimicrobials used to treat infection in animals (Melchior et al., 2006; Vargová et al., 2023). The spatial heterogeneity of biofilms (Wimpenny et al., 2000), along with the activation and expression of novel, biocide-resistant genes through early stress response, are hypothesized to inhibit the effectiveness of biocides against biofilms (Gilbert & McBain, 2001; Russell & Chopra, 1996). Furthermore, the physical barrier created by the extracellular polymeric matrix of the biofilm protects bacteriological cells within the matrix from the effects of UV light (Elasri & Miller, 1999) as well as extreme temperature, salinity, and pH (Yin et al., 2019). Since each surface that contacts an infected udder (udder cloths, milkers' hands, and milking liners) represents an opportunity for disease transmission (Vargová et al., 2023), the challenges associated with biocide-resistant biofilms and pathogens represent an explicit problem for dairies.

Limited focus has been cast on implementing microbial-resistant surfaces at critical control points (CCP) to prevent disease within dairies. Saied et al. (2011) is believed to be the first and only prior study examining the effects of silver particles on mastitis rates in cattle. The researchers present evidence for the rapid onset of antibacterial activity of silver particles in milk inoculated with Staphylococcus aureus and recommend using silver particles as an alternative to antibiotics in subclinical mastitis infections (Saied et al., 2011). For centuries, silver's non-toxic, effective antibacterial properties have been documented and leveraged to control infection (Lansdown, 2006). However, little work has been done on creating polymer matrices with inherently antimicrobial agents (such as silver); this gap in the research is especially glaring given the recent decisions by the United States Environmental Protection Agency (EPA) recognizing copper surfaces as effective against disease-causing microorganisms, including multi-drug-resistant strains of bacteria and, more recently, coronaviruses (U.S. Environmental Protection Agency, 2021). Further research into this arena of microbial-resistant surfaces could have positive implications for use in livestock, food production, and veterinary settings.

Various antimicrobial particles such as zinc oxide, titanium dioxide, and silver are known to inhibit microbial growth and biofilm formation. Still, no significant efforts have been made to evaluate the potential to use these materials on CCP within the agricultural industry to inhibit biofilm development. The present disclosure evaluates the mechanical and antimicrobial characteristics of polymers used in the milk production process and investigates the efficacy of enhancing industry-standard polymers with antimicrobial additives.

### EXAMPLES

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Example 1—Polymeric Materials Enhanced with Antimicrobial Additives for Use in Dairy Milking Applications

The persistent challenge of mastitis infections within dairy herds, exacerbated by biofilms on dairy liners, necessitates innovative solutions to safeguard animal health and enhance dairy farm productivity. The present disclosure pertains to the development of novel engineered materials, incorporating antimicrobial agents into the polymer matrix of dairy liners to establish a passive defense against pathogenic microbes, thus reducing the spread of mastitis without resorting to increased antibiotic interventions. In some aspects, the present example relates to materials and composition comprising zinc oxide (ZnO) as an antimicrobial agent when embedded within a polymer matrix resembling those used in commercial dairy liners. The studies disclosed herein employ the ASTM International Method E2180 to assess the antibacterial activity against Staphylococcus aureus ATCC 6538, demonstrating significant bacterial count reductions correlating with ZnO concentrations.

The present example provides an efficacious and cost-effective approach to material science applications in agriculture by integrating passive microbial-resistant technologies into dairy operations. By examining the antimicrobial effectiveness of ZnO-embedded surfaces, the present example provides a strategy for reducing reliance on antibiotics in dairy herds, aligning with sustainable agricultural practices.

### Materials

The role of milking liners as the sole point of direct contact between the milking machine and the cow emphasizes the importance of their production method for both mechanical and, in this case, antimicrobial properties. The interaction between the teat and the liner significantly influences the efficacy of the milking machine. Given the wide variety (i.e., hundreds) of commercial liners available globally and their complex chemical composition, which can include up to twenty different ingredients, maintaining high standards in dimensions and physical attributes across different batches is important for optimal milking performance and reliability (Coombs, 1992).

For this study, a platinum-cure silicone polymer (Smooth-Sil 950, Smooth-On, Inc., Macungie, PA, USA) was chosen as the test material due to its commercial availability, simple processing requirements, and similarity to the physical characteristics of proprietary polymers used in many common dairy liners. Zinc Oxide provided by Buffalo Technology Group, Ltd (Dimmitt, Texas, USA), served as the antimicrobial test agent.

### Mold Design and Fabrication

A custom, 5-piece aluminum mold was designed using Fusion 360 (Autodesk, Inc, San Francisco, CA, USA) to cast two, 4 inches by 12 inches test sheets with a thickness of 0.12 inches, mimicking the wall thickness of important features within the Pro-Square dairy liner (Pro-Square DPX CR, IBA Dairy Supplies, Sutton, MA, USA). The parts were machined from 6061-T6511 extruded aluminum (Online Metals, Seattle, WA, USA) using a Tormach 1100MX CNC Mill (Tormach, Inc, Madison, WI, USA). Special attention was given to the flatness of the interior faces and the thickness of the spacers, utilizing a fly cutter (Tormach TTS Super Fly Cutter) with a polished carbide insert for precision. Post-machining, the interior faces were polished to a semi-mirror finish, and the mold was prepared with mold release (Ease Release 200, Mann Release Technologies, Macungie, PA, USA) before assembly.

### Polymer Processing and Molding

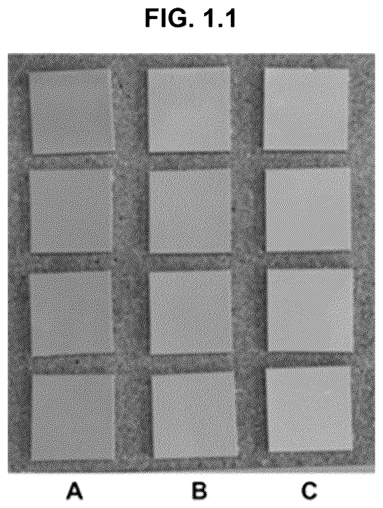

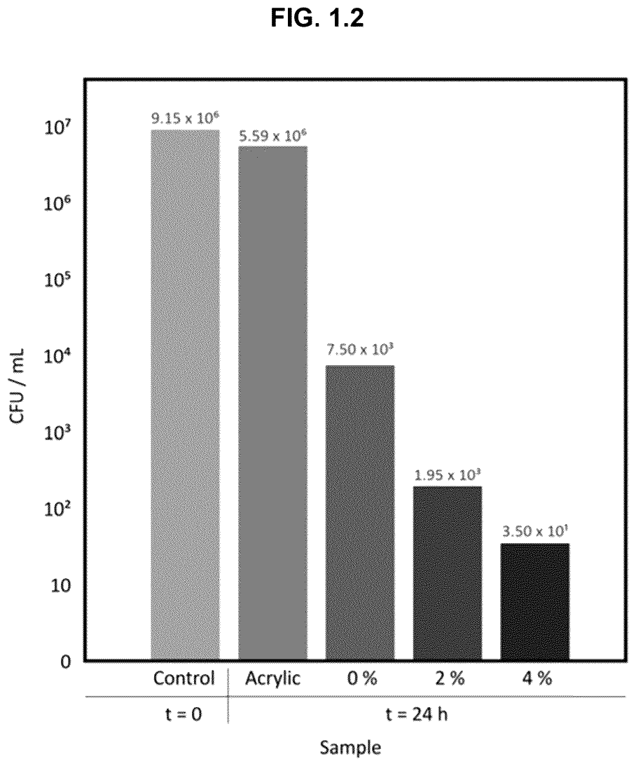

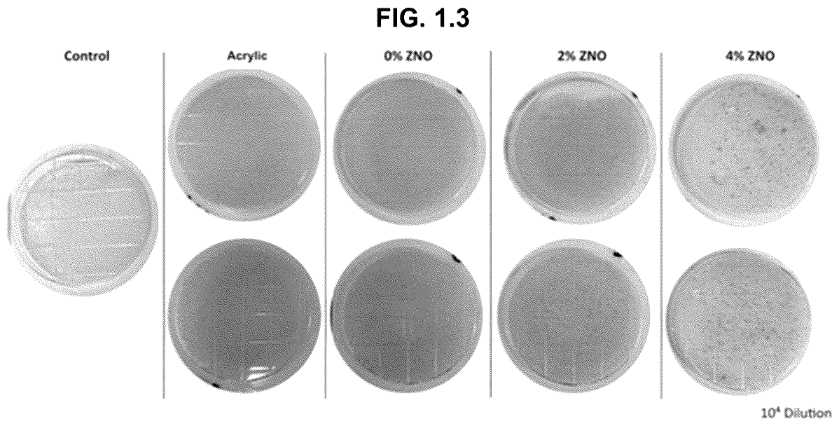

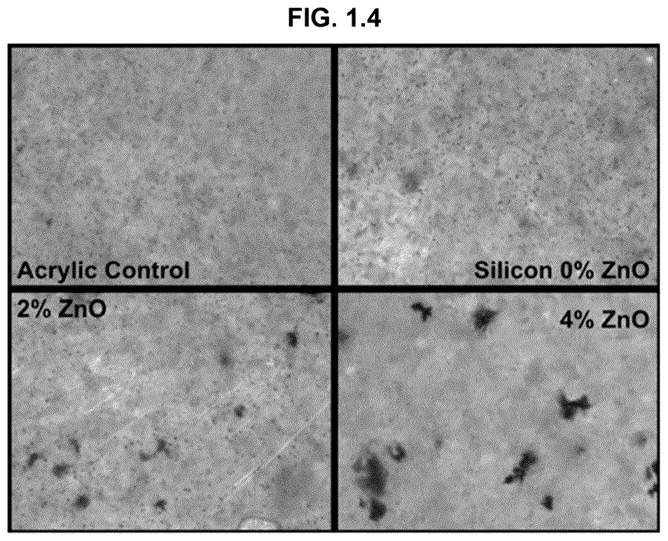

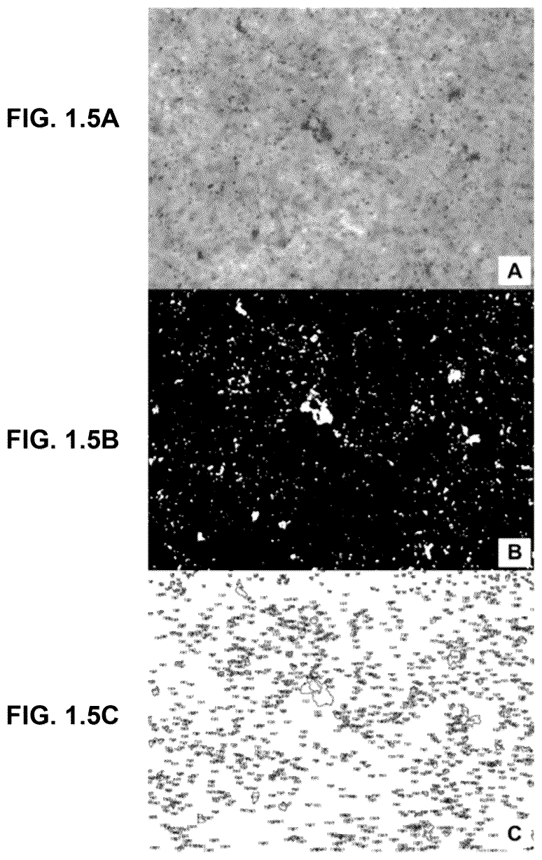

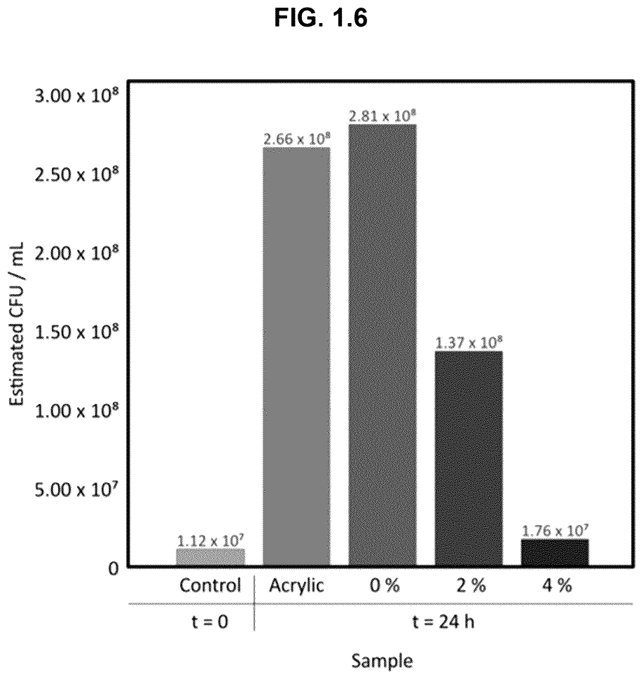

A two-part silicone polymer was prepared at a 10:1 resin-to-hardener ratio, with ZnO added at 0, 2, and 4% (by weight) concentrations to evaluate its antimicrobial efficacy. The mixture underwent a two-step blending process using a planetary mixer (ARE 310, Thinky USA, Laguna Hills, CA, USA) to minimize agglomeration. The mixed polymer was then injected into the mold, which was positioned at a 45-degree angle to facilitate air evacuation. The mold was subjected to a pressure chamber at ambient temperature under 50 psi for 24 hours to reduce air pockets. Subsequently, the samples were released, washed, and cut into coupons for testing (FIG. 1.1).

### Trial 1: Antimicrobial Efficacy Testing—Standardized ASTM E2180-18

The antimicrobial activity of the samples was assessed following ASTM E2180-18, a standard test method for determining the activity of incorporated antimicrobial agents in polymeric or hydrophobic materials. This method evaluates the effectiveness of antimicrobials in materials by measuring the percent reduction in surviving populations of challenge bacterial cells at 24 hours compared to a non-treated control. The test involves maintaining an aqueous-based bacterial inoculum in close, uniform contact with the treated material in a “pseudo-biofilm” state. Calculations for average count of colonies, log₁₀ reduction, and percent reduction were performed to analyze the data.

The test microorganism(s) selected for this test was Staphylococcus aureus 6538. This bacterium is spherical-shaped, gram-positive, and facultative anaerobe. Staphylococcus species are known for their resistance to antibiotics like methicillin. S. aureus can cause various health conditions ranging from commensal skin colonization to severe diseases like pneumonia and toxic shock syndrome (TSS). It is frequently used as a model for gram-positive bacteria in various test methods. Although it is hard to disinfect, it does demonstrate susceptibility to low-level disinfectants. Staphylococcus aureus is also a major cause of mastitis in dairy cattle. Mastitis is an inflammation of the udder tissue, which can be caused by various bacterial pathogens. S. aureus can cause chronic and subclinical infections in the udder, leading to reduced milk production and quality. The bacterium can also be transmitted to humans through the consumption of contaminated milk, causing a range of infections. Effective control measures, such as good milking hygiene and the use of antibiotics, can help prevent and treat mastitis caused by S. aureus.

### Trial 2: Milk-Based Antimicrobial Efficacy Testing

To further relate the antimicrobial efficacy of the experimental polymers to the real-world application on farms, a second trial was designed using unpasteurized whole milk as the inoculum and nutrient broth. Raw milk was collected from a hospital milking parlor at a dairy in the Texas Panhandle. When cows in milk are diagnosed as being infected with mastitis, they are pulled from the primary milking parlor and instead milked at a secondary milking parlor often called the “hospital pen” or “hospital parlor” while under mastitis treatment protocols. The milk from these hospital parlors has an exceptionally high microbial load and is unfit for human consumption. Samples were taken from the bulk storage tank at the hospital parlor so that the bacterial colonies present in the milk were directly associated with known cases of mastitis in the Texas Panhandle. This methodology, while less documented than standardized cultures and inoculation protocols, allows the experimental polymers to be tested directly against the microorganism populations that are known to be associated with mastitis infection in the Texas Panhandle.

The protocol was developed as an augmentation of ASTM E2180-18 with the objective being to develop a pseudo-biofilm on the surface of the polymers by exposing them to a nutrient-rich media that includes microbial cells, biological and nonbiological matter-raw milk. Three samples were prepared by pouring 17.5 g of resin into an 88 mm diameter petri plate (VWR); samples included 2% (by weight) ZnO, 4%, and 0% ZnO (FIG. 1.3). Samples were cured in a pressure chamber at 50 psi for 24 hours.

Butterfield's Phosphate Buffered Dilution Water (BPBDW) was prepared by dissolving 34 g of KH2PO4 in 500 mL of steam-distilled water. The pH was adjusted to 7.2 with a 1 N NaOH solution. Following pH adjustment, the volume was brought up to 1 L with distilled water. The solution was then sterilized by autoclaving at 121° C. for 30 minutes. Each test plate was inoculated with 3 mL of unpasteurized raw milk from the hospital parlor of a Texas Panhandle dairy. A gentle swirling motion was used to fully wet the polymer surface of the sample with milk.

Samples were placed in a shallow pan with a Petri dish containing distilled water situated in the center. This assembly was loosely covered with aluminum foil and allowed to incubate at room temperature. Post-incubation, the plates were washed with 27 mL of BPBDW. A stainless-steel lab spatula was used to gently scrape the milk from the surface and sides of each plate. The effluent from each sample wash was collected in a 200 mL glass beaker. The beaker was then covered with wax film and swirled until all milk particles were dissolved.

For each sample, serial dilutions were prepared by adding 9 mL of BPBDW into three Falcon tubes. One milliliter of the effluent, assumed to represent a 1:10 dilution of the initial inoculate concentration, was transferred into the first Falcon tube containing 9 mL of BPBDW. This mixture was shaken by hand for 25 strokes, each exceeding 1 inch in amplitude. Subsequently, 1 mL of this diluent was pipetted onto a peel plate to achieve a 1:100 dilution. Another 1 mL from this mixture was transferred to the next Falcon tube to prepare a 1:1000 dilution, which was also plated on a peel plate, and the process was repeated one more time to create a 1:10000 dilution. The inoculated peel plates were incubated at 32.5° C. for 36 hours. The plates were then photographed (FIG. 1.3) using a DFK33UX264 Camera (The Imaging Source, LLC, Charlotte, NC, USA). Five images were captured from each plate and analyzed using the Particle Analysis feature of ImageJ software (National Institutes of Health, USA) (FIG. 1.4). The mean number of colonies was multiplied by the scale factor to estimate the number of colonies on the entire plate. This structured and detailed methodology provides clear and reproducible steps for the preparation, inoculation, and analysis of samples using BPBDW and serial dilution techniques for microbial analysis.

### Results and Discussion

The incorporation of Zinc Oxide (ZnO) as an antimicrobial agent into the platinum-cure silicone polymer used for milking liners showed a significant reduction in bacterial count, indicating effective antimicrobial activity. The results, as detailed in Table 1.1 and illustrated in FIG. 1.2, demonstrate that with an increase in the concentration of ZnO, there is a notable increase in the log reduction of bacterial count. Specifically, a 2% ZnO incorporation resulted in a 4.28 log reduction, while a 4% ZnO addition achieved a higher log reduction of 5.34. These results underscore the effectiveness of ZnO as an antimicrobial additive in the silicone polymer matrix used for creating dairy liners.

The milk testing results revealed a discernible threshold between 2% and 4% loading of zinc oxide (ZnO) after 24 hours of exposure, with an approximate rate of 2 square inches per mL milk (FIG. 1.3). Images captured after 24 hours of exposure to the test materials and 36 hours of incubation provided visual evidence. Serial dilution by a factor of 10\hat{ }4 was conducted on samples, followed by an assessment of colony number and average size. Notably, colonies exhibited an increase in size proportional to nutrient availability, as supported by previous studies (Shao et al., 2017). A statistically significant difference in average colony diameter, corresponding to a greater number of colony-forming units (CFUs), was observed with increasing ZnO concentration. The initial milk inoculated was measured at approximately 2.81×10⁸ CFU/ml. Subsequent exposure at room temperature for 24 hours indicated a reduction in CFUs, with the 4% ZnO sample showing a decrease to 1.76×10⁷ CFU/ml, while the 2% ZnO sample had 1.37×108 CFU/ml. Despite a lower log reduction compared to water-based samples, noticeable efficacy was observed in the 4% ZnO samples, as depicted in FIG. 1.3.

The experimental findings highlight the potential of ZnO as a powerful antimicrobial agent when incorporated into the material used for milking liners. The significant log reduction in bacterial count with ZnO incorporation not only indicates the effectiveness of ZnO in inhibiting bacterial growth but also suggests a dose-dependent relationship between ZnO concentration and antimicrobial activity. The observed 4.28 log reduction at 2% ZnO concentration and a further increase to 5.34 log reduction at 4% ZnO concentration (FIG. 1.6) support the hypothesis that higher concentrations of ZnO lead to greater antimicrobial efficacy.

Moreover, the use of custom-designed mold and precision manufacturing techniques, as described in the Methods and Materials section, contributed to the reproducibility and reliability of the antimicrobial testing. The meticulous preparation and characterization of the polymer-ZnO composites underline the importance of controlled experimental conditions in evaluating the efficacy of antimicrobial additives.

### Conclusions

The incorporation of ZnO into the platinum-cure silicone polymer used for milking liners presents a promising strategy for enhancing the antimicrobial properties of dairy equipment. This study contributes to the ongoing efforts to improve the safety and efficiency of dairy farming operations through innovative material solutions. Further investigations into the optimal concentrations of ZnO, its compatibility with different polymer matrices, and the economic viability of this approach will be crucial for its successful implementation in the dairy industry. These results are particularly relevant for the dairy industry, where the hygiene and safety of milking equipment are paramount. The interaction between the cow's teat and the liner is an important point for potential microbial contamination, which can affect milk quality and animal health. By incorporating ZnO into the liners, there is a potential to significantly reduce the microbial load, thereby enhancing the overall hygiene of the milking process.

It is important to consider the implications of these findings on the design and manufacturing of dairy liners. The ability to incorporate antimicrobial agents directly into the liner material offers a proactive approach to hygiene, potentially reducing the reliance on post-milking disinfection procedures. However, further research is needed to assess the long-term stability of ZnO within the polymer matrix, its impact on the mechanical properties of the liners, and the safety of ZnO in contact with food products.

TABLE 1.1
S. aureus ATCC 6538 Percent Reduction
and Log₁₀ Reduction Compared to Control

| | | | Percent | Log₁₀ |
|---|---|---|---|---|
| | | | Reduction of | Reduction of |
| | | | Microorganism | Microorganism |
| Contact | | Average | Compared to | Compared to |
| Time | Test Article | CFU/mL | Control | Control |
| Time Zero | Acrylic Control | 9,150,000 | N/A | N/A |
| 24 Hours | Acrylic Control | 5,950,000 | N/A | N/A |
| | 0% | 7,500 | 0.998739496 | 2.9 |
| | 2% | 195 | 0.999967227 | 4.48 |
| | 4% | 35 | 0.999967227 | 5.23 |

### Example 1 References

1. Coombs, T. (1992). The importance of maintaining mechanical properties in milking liners for optimal performance. Dairy Journal, 12(3), 245-251.
2. ASTM International. (2018). ASTM E2180-18, Standard Test Method for Determining the Activity of Incorporated Antimicrobial Agent(s) In Polymeric or Hydrophobic Materials. ASTM International, West Conshohocken, PA, doi:10.1520/E2180-18.
3. Seaberg, J., Clegg, J. R., Bhattacharya, R., & Mukherjee, P. (2023). Self-therapeutic nanomaterials: Applications in biology and medicine. Materials Today, 62, 190-224.
4. Applerot, G., Lipovsky, A., Dror, R., Perkas, N., Nitzan, Y., Lubart, R., & Gedanken, A. (2009). Enhanced antibacterial activity of nanocrystalline ZnO due to increased ROS-mediated cell injury. Advanced Functional Materials, 19(6), 842-852.
5. Brunner, T. J., Wick, P., Manser, P., Spohn, P., Grass, R. N., Limbach, L. K., . . . & Stark, W. J. (2006). In vitro cytotoxicity of oxide nanoparticles: comparison to asbestos, silica, and the effect of particle solubility. Environmental science & technology, 40(14), 4374-4381.
6. Jiang, X., Tong, M., Lu, R., & Kim, H. (2012). Transport and deposition of ZnO nanoparticles in saturated porous media. Colloids and Surfaces A: Physicochemical and Engineering Aspects, 401, 29-37.
7. Kobayashi, M., Komori, J., Shimidzu, K., Izaki, M., Uesugi, K., Takeuchi, A., & Suzuki, Y. (2015). Development of vertically aligned ZnO-nanowires scintillators for high spatial resolution x-ray imaging. Applied Physics Letters, 106(8).
8. Pasquet, J., Chevalier, Y., Pelletier, J., Couval, E., Bouvier, D., & Bolzinger, M. A. (2014). The contribution of zinc ions to the antimicrobial activity of zinc oxide. Colloids and Surfaces A: Physicochemical and Engineering Aspects, 457, 263-274.
9. Shao X, Mugler A, Kim J, Jeong H J, Levin B R, Nemenman I. Growth of bacteria in 3-d colonies. PLOS Comput Biol. 2017 Jul. 27; 13(7):e1005679. doi:10.1371/journal.pcbi.1005679. PMID: 28749935; PMCID: PMC5549765.
10. Chupani, L., Niksirat, H., Velíšek, J., Stará, A., Hradilová, Š., Kolařík, J., . . . & Zusková, E. (2018). Chronic dietary toxicity of zinc oxide nanoparticles in common carp (Cyprinus carpio L.): tissue accumulation and physiological responses. Ecotoxicology and environmental safety, 147, 110-116.
11. Kadiyala, U., Turali-Emre, E. S., Bahng, J. H., Kotov, N. A., & VanEpps, J. S. (2018). Unexpected insights into antibacterial activity of zinc oxide nanoparticles against methicillin resistant Staphylococcus aureus (MRSA). Nanoscale, 10(10), 4927-4939.

### Example 2—Enhancing Dairy Processing Equipment with Antimicrobial Silicone Resin: the Effects of Zinc Oxide on Mechanical Properties

### Summary

The present disclosure highlights the crucial role of maintaining the integrity of milk contact surfaces to ensure product quality and safety in dairy processing. As disclosed herein, by incorporating zinc oxide into silicone resin, traditionally used in milking liners, the disclosed compositions and materials enhance the material's antimicrobial properties without compromising its essential mechanical characteristics. The present disclosure addresses the limitations of conventional materials like metals, which can suffer from corrosion, off-flavors, and bacterial contamination.

The present disclosure pertains to integrating ZnO into silicone resin at varying, but non-limiting, concentrations (e.g., 1%, 2%, and 4% w/w). The disclosed materials and compositions combat the formation of biofilms on milking liners, a common issue leading to infection transmission in dairy farms. The data disclosed herein demonstrates the minimal effects of ZnO on the elasticity and hardness of the silicone resin, crucial for the durability and functionality of dairy processing equipment.

It was observed that the addition of ZnO up to 2% concentration did not significantly alter the silicone's hardness or stiffness, a notable finding was that a 4% ZnO concentration resulted in a statistically significant increase in material stiffness. This observation suggests an improvement in the material's physical properties at higher ZnO concentrations, potentially enhancing the performance of dairy processing applications.

The present further pertains to techniques to ensure uniform distribution of ZnO particles within the silicone matrix, addressing an important challenge in composite material science. The successful integration of antimicrobial properties into silicone resin, validated by the consistent coloration of the fabricated plaques, represents a significant advancement in engineering materials for the dairy industry, offering a novel solution for improving the hygiene and mechanical integrity of milking equipment.

### Introduction

The dairy industry is an important sector where meticulous attention should be given to the quality and safety of milk and milk products. This integrity of milk and milk product contact surfaces should be maintained, which should be smooth, impermeable, free from cracks and fissures, non-porous, corrosion-resistant, durable, non-contaminant, and easily cleanable to meet sanitary design criteria (Prasad, 2023). Traditional materials like metals and their alloys, including aluminum, copper, and iron, have been widely used in dairy processing equipment but have shown limitations due to the development of off-flavors, material discoloration, corrosion, and the potential generation of hazardous bacteria (Azevedo et al., 2016; Prasad, 2023).

To overcome these challenges, silicone resin has emerged as a preferred material for milking liners in the dairy industry, attributed to its superior corrosion resistance, which ensures the taste of fresh milk is not compromised and guarantees equipment reliability and product purity (Prasad, 2023). However, despite its advantages, silicone resin is prone to biofilm development due to continued contact with bacteria from the animals, which poses a risk of spreading bacteria as the liners are used for multiple milkings (Mein, 2012; Prasad, 2023).

Biofilms are complex structures formed by microorganisms that adhere to surfaces and are encased within a protective matrix. These biofilms are significant because they can harbor bacteria that lead to the spread of diseases among cows during the milking process (Khaledi et al., 2015). A particular concern in this context is mastitis, an inflammatory condition of the mammary gland primarily caused by bacterial infections. Mastitis can result from the transfer of bacteria between cows via contaminated milking liners, leading to significant economic losses for dairy farmers due to decreased milk production, altered milk quality, and increased treatment and management costs (Mein, 2012; O'Callaghan & Meaney, 1998).

Engineered materials, often composite in nature, are developed through the integration of multiple material phases to achieve mechanical properties superior to those of each individual constituent (Kundapur & Unnikrishnan, 2023). These composites typically combine a strong matrix phase with a tougher, yet less flexible, fiber phase to enhance structural rigidity and strength. Silicone elastomers, a key example of such materials, gain their mechanical integrity from both chemical crosslinking and filler reinforcement, necessitating effective interaction between the polymer molecules and filler particles for optimized reinforcing effects (Hatamleh & Watts, 2010; Kamonchaivanich & Somwangthanaroj, 2003).

In the context of dairy farming, silicone liners undergo significant repetitive stress due to the combination of vacuum and compression during the milking process. These mechanical stresses, influenced by the vacuum, liner properties, liner on-time, and teat anatomy, lead to changes in teat length and tissue thickness due to the forces exerted by the vacuum and the collapsing liner (Hamann, 1991; Hamann & Stanitzke, 1990; Neijenhuis et al., 2001). The interaction between these factors can result in high pressure at the most incompressible part of the teat end, where the liner encounters the greatest resistance (Mein et al., 2003). Studies on various liner designs have indicated that the design of the liner plays a more significant role in influencing milking characteristics than any other factor related to the milking machine, with notable differences observed in liner collapse, the incidence of liner slips, and machine operation times among different liners (O'Callaghan & Meaney, 1998).

Despite the important role of liners in the milking process, there is a lack of consensus on what differentiates an adequate liner from an inferior one. Liner design remains largely empirical, highlighting the need for consistent mechanical properties in the material along with a method for measuring the load distribution on the teat. Such a method could facilitate the quantification of liner characteristics and the development of customized liners for specific breeds or herds. It could also be used to evaluate existing liner designs, explore the impact of changing liner properties, and investigate the effects of liner aging.

Recent studies have also explored the gelation behaviors and mechanical properties of silicone resins for specialized applications, such as constructing breast cancer training models, indicating the versatility and importance of understanding the mechanical behaviors of silicone-based materials (Kamonchaivanich & Somwangthanaroj, 2003). Additionally, research into silicone/epoxy hybrid resins has shown potential for tunable mechanical and interfacial properties, which could benefit the additive manufacture of soft robots and other innovative applications (Joseph et al., 2021). The thermal stability, mechanical, and optical properties of novel addition-cured composites of silicone resin further demonstrate the ongoing advancements in silicone resin technology, offering enhanced properties for various applications (Chen et al., 2015).

Given these challenges, the present disclosure aims to explore the modification of silicone resin used in dairy liners by incorporating zinc oxide (ZnO) as an antimicrobial additive at concentrations of 1%, 2%, and 4% by weight. The objective is to evaluate the impact of ZnO on the mechanical properties of silicone resin, including tensile strength and hardness, and to understand how these modifications can enhance the material's performance in dairy processing applications (Prasad, 2023). This research is significant as it seeks to offer insights into optimizing materials for food contact surfaces in the dairy industry, focusing on enhancing both hygiene and mechanical integrity to improve equipment reliability, product purity, and, ultimately, animal and consumer health.

### Materials and Methods

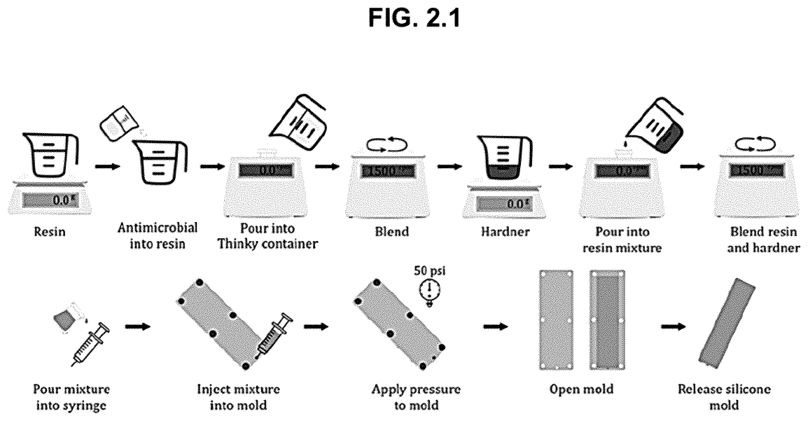

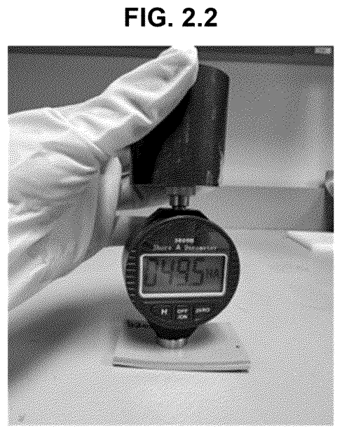

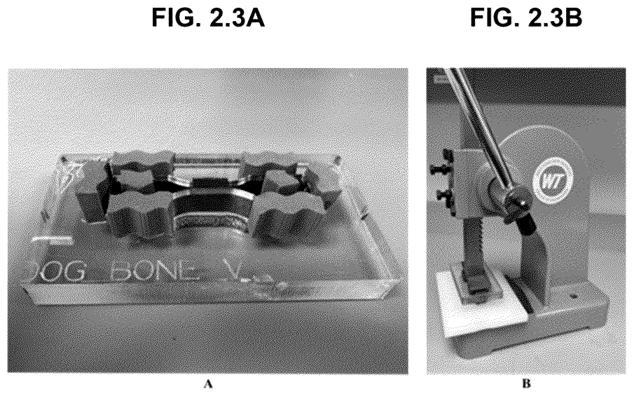

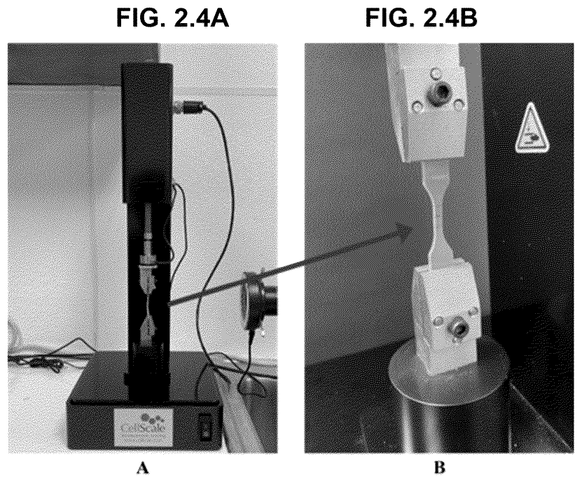

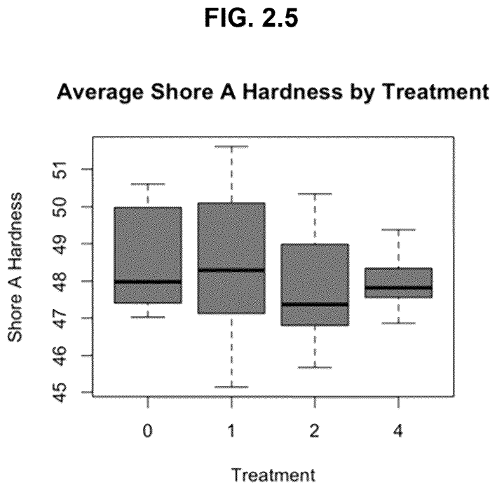

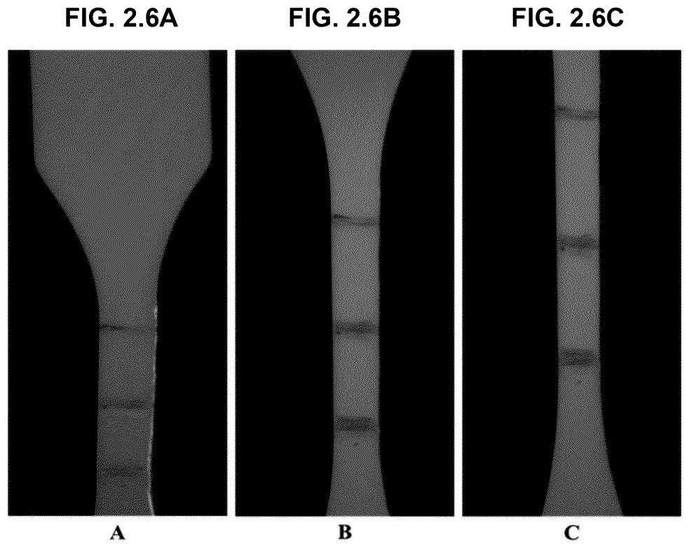

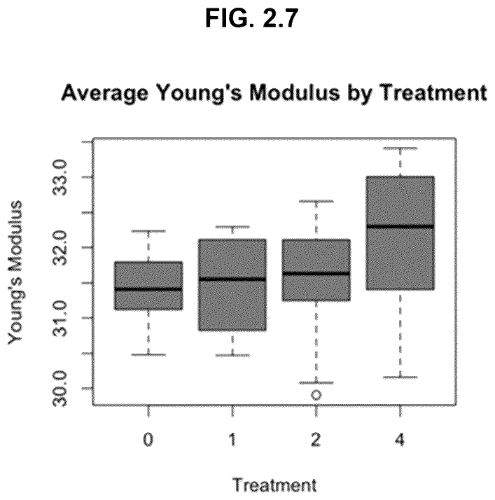

The consistent mechanical properties of milking liners are important, as they represent the sole point of direct contact between the machine and the cow. The efficacy of the milking machine is significantly influenced by the interaction between the teat and the liner. With hundreds of commercial liners available globally, the complexity of their chemical composition, including up to twenty different ingredients blended homogeneously, is notable. Furthermore, to ensure optimal milking performance and reliability, it is also important for liners to maintain high standards in dimensions and physical attributes across different batches (Coombs, 1992). FIG. 2.1 shows the laboratory-scale technique that allowed for: (a) the even distribution of ZnO particles within the polymer matrix, (b) the shaping of the ZnO-enhanced resin into predetermined molded forms, and (c) the production of cured samples devoid of major air inclusions. Fabricating these composite coupons used a pioneering technique designed to achieve uniform distribution of zinc oxide particles within the composite matrix. This approach addresses an important aspect of composite material science: the precise positioning and concentration of additives to optimize material properties.

A platinum-cure silicone polymer (Smooth-Sil 950, Smooth-On, Inc., Macungie, PA, USA) was selected as the test material because it is commercially available, has simple processing requirements, and approximates the physical characteristics of the proprietary polymers used in many common dairy liners. Zinc Oxide supplied by Buffalo Technology Group, Ltd (Dimmitt, Texas, USA) as the antimicrobial test agent.

A custom, 5-piece aluminum mold was designed using Fusion 360 (Autodesk, Inc., San Francisco, CA, USA). The mold was designed to simultaneously cast 2, 10 cm by 30.5 cm test plaques measuring 3 mm thick. The 3 mm thickness was selected because it is the measured wall thickness of important features within the popular Pro-Square dairy liner (Pro-Square DPX CR, IBA Dairy Supplies, Sutton, MA, USA).

The mold parts were machined from 8 mm in by 102 mm rectangle bars of 6061-T6511 extruded aluminum (Online Metals, Seattle, WA, USA) using a Tormach 1100MX CNC Mill (Tormach, Inc, Madison, WI, USA). The most important features of the mold were the flatness of the interior faces and the thickness of the spacers. To make these features as accurate and planar as possible, a fly cutter (Tormach TTS Super Fly Cutter) with a polished carbide insert (SEHT43AFNN-X83) was used to machine the surface of the parts, and special care was taken when programming tool paths and designing work-holding fixtures. Once machined, the interior faces of the mold were polished to a semi-mirror finish using an aluminum polishing compound and cotton buffing wheels. To prepare for molding, the mold was cleaned with glass cleaner, denatured alcohol, and then coated with mold release (Ease Release 200, Mann Release Technologies, Macungie, PA, USA) and then assembled using 18, 0.25 in by 20-0.75 in socket head screws.

The two-part silicone polymer was mixed at a 10:1 resin-to-hardener ratio per manufacturer instructions. The antimicrobial additive, ZnO, was added to the mixture at 0, 1, 2, and 4 percentage by weight basis (wt/wt), where the weight of the additive is expressed as a percentage of the total weight of the polymer. The polymer was mixed in a two-step process to decrease agglomeration without decreasing pot life. The resin was first metered into a 300 ml HDPE mixing jar then ZnO was added to the jar. This mixture was blended via planetary mixing (ARE 310, Thinky USA, Laguna Hills, CA, USA) for 2 minutes at 1500 rpm. Then, the hardener was added, and the mixture was blended for 2 minutes at 1500 rpm. While blending, the mold was arranged in a bench vise at a 45-degree angle such that the injection port was below the exhaust ports of the mold. Once blended, the mixture was quickly poured into a 300 ml barrel syringe with a catheter tip and injected into each cavity of the aluminum mold. Care was taken to inject the mixture under consistent pressure and to allow adequate time for air to evacuate the mold through the top exhaust ports. Once resin fully filled both cavities, the bottom injection ports were sealed with a 0.3125 in by 18-1 in bolt. The bolt was screwed 12 mm into the injection port assembly, injecting more resin into the mold cavity and decreasing the volume of air close to the injection ports.

The mold was then placed in a pressure chamber at ambient temperature under 3.5 bar to decrease the number and size of air pockets within the samples. After 24 hours, the mold was removed from the pressure chamber, and the molded samples were released from both cavities of the mold. The samples then underwent a two-step wash in dish soap and deionized water to remove the mold release from the surface. An overview of this process is shown in FIG. 2.1. The molded samples were then cut into 44.5 mm by 70 mm coupons with a rotary cutter.

### Shore A Hardness Testing (ASTM D2240)

Shore A hardness is a measure of the hardness of a material, typically used for rubber or soft plastics. The Shore A scale gives a numerical value to the hardness, with higher numbers indicating a harder material. The Shore A hardness was taken using a method that approximates ASTM D2240 using a handheld digital durometer (Model No. 3805B, L. S. Starrett Company, Athol, MA, USA) according to ASTM D2240. Two castings were made for each of the 4 treatments (ZnO concentrations of 1%, 2%, and 4% by weight). To achieve the minimum thickness required for testing, plies were constructed by stacking two coupons, cut from the same plaque, together to form a hardness test sample. In total, 40 hardness test samples were constructed (10 from each treatment). On each sample, 5 areas were identified that were at least 6.5 mm from the edge and 6.5 mm from each other. A 605 g steel weight was added to the top of the durometer to apply consistent pressure, great enough to fully bury the probe tip in the polymer during each reading. The weight was balanced laterally during measurement (as shown in FIG. 2.2), and no additional pressure was applied in the vertical direction. Five readings were taken from each of the 5 areas on each of the 40 samples. The average value of the 25 readings is reported as the sample hardness per ASTM specification.

The data were analyzed using R-Studio (Posit team, Boston, MA, USA). A Levene Test showed the data to be normally distributed (P=0.10), and a one-way ANOVA revealed no statistical difference in hardness at any treatment (P=0.48).

### Tensile Testing (ASTM D638)

One casting was made for each of the 4 treatments. Dumbbell-shaped samples (n=16) were cut from each casting using a steel rule cutting die (ASTM D638-V) and a 2-ton arbor press (FIGS. 2.3A-2.4B). Each of the 64 samples was tested in triplicate for a total number of 192 tests (4 treatments×16 samples×3 tests per sample).

A UniVert Mechanical Test System (CellScale Biomaterials Testing, Waterloo, ON, Canada) was used to test the elasticity of each sample (FIGS. 2.5A-2.5B). Univert software (ver-12.51) was used for data acquisition with a feature to capture sequential images using a scientific camera. The experimental setup and procedure were improved upon from the setup of Kundapur and Unnikrishnan (2023) and are shown in FIGS. 2.4A and 2.4B. The load cell used in the setup was a semiconductor strain gauge-based with an accuracy of 0.2% of the rated full-scale load up to 100 N. The load cell was calibrated using a known mass of 100 g provided by the manufacturer. The distance between the grippers was calibrated using a compression spring of known length, which was also supplied by the manufacturer. This distance calibration procedure was performed after every 5 samples, and the height was also independently validated using digital calipers. The grippers were set to 40 mm, and the sample was loaded such that when the grippers were tightened, the midpoint of the sample was aligned with the midpoint between the grippers.

Each sample was tested in 3 successive test replicates with a preload of 0.1 N and time durations set for stretch (30 s), recovery (10 s), and rest (10 s). The strain was limited to a maximum of 50% to ensure that the samples remained within the elastic deformation range (FIG. 2.5). This approach helped avoid any damage to the samples and prevented them from slipping out of the grips due to changes in volume while clamped. Data was gathered at a frequency of 5 Hz, and images were captured at 1 Hz (FIGS. 2.6A-2.6C). The 3 test replicates yielded approximately 765 data points for each sample. The data was analyzed using R-Studio (Posit team, Boston, MA, USA). The strain (denoted as ε) and stress (σ) for each point were calculated using Eqs. 1 and 2, respectively. The initial length (L°), displacement (ΔL) and force (F) were captured with the software. The cross-sectional area (A) for each sample was 7.314 mm². The strain (independent variable) and stress (dependent variable) for each sample were plotted and a linear regression was generated for each plot (the minimum R² value for each of the 64 tests was 0.95 with an average of 0.96). The slope of the regression represents the stiffness of the specimen, which in this linear case is Young's Modulus. Young's Modulus measures the stiffness of a material, which indicates the tensile stiffness or rigidity of the material. Higher values of Young's Modulus mean the material is stiffer. The arithmetic mean of the moduli was calculated for each sample per ASTM specification and are shown arranged by treatment in FIG. 2.5. A Levene's Test showed the data to be normally distributed (P=0.05) and a one-way ANOVA revealed a statistically significant difference in treatment means at a 0.05 confidence level. Therefore, a Dunnett's test was performed to compare the Average Young's Modulus for the 1%, 2%, and 4% treatments to the 0% treatment.

$$ε = Δ L / ( L ° ) \qquad ( 1 )$$

$$σ = F / ( A ° ) \qquad ( 2 )$$

The statistical significance (p-value) are measures that help determine whether the observed effects are likely to be due to chance. In scientific studies, a p-value less than 0.05 is often considered statistically significant, meaning there is less than a 5% probability that the observed differences happened by chance. Hence, the significance threshold for this study was set at 0.05.

### Results and Discussion

Studies on various liner designs have indicated that the design of the liner plays a more significant role in influencing milking characteristics than any other factor related to the milking 2machine, with notable differences observed in liner collapse, the incidence of liner slips, and machine operation times among different liners (O'Shea, 1993).

The present disclosure further pertains to the disclosed method that provides for (a) the even distribution of ZnO particles within the polymer matrix, (b) the shaping of the ZnO-enhanced resin into predetermined molded forms, and (c) the production of cured samples devoid of major air inclusions. Planetary mixing was utilized to meet these goals, as detailed in FIG. 2.1. Additionally, an important step in this methodology includes the manual injection of the mixture using standard catheter tip syringes from the bottom of the mold and conducting the curing process under pressure to further ensure the integrity and uniformity of the final product. The color of the three components of the mixture allowed for quick, accurate validation of zinc oxide dispersal within the cured plaques. The resin (white) and the catalyst hardener (deep blue) blended in a 10:1 ratio reveal a rich blue plaque when cured. Zinc oxide is a highly effective white pigment often used in paints to brighten whites. Therefore, when mixed into the polymer it lightens the blue color noticeably. A plaque with consistent color across the surface and cross-sectional areas demonstrates a process that achieved consistent blending of hardener and resin along with consistent dispersion of ZnO particles throughout the matrix. All plaques manufactured in the technique displayed consistent coloring throughout the polymer matrix.

Average Shore A Hardness was 48.59, 48.52, 47.71, and 47.99 for 0, 1, 2, and 4% treatments, respectively (Table 2.1, FIG. 2.5). The data was normally distributed, supporting the methodology used to disperse ZnO consistently throughout the polymer matrix of each treatment and the methodology used to take readings with a handheld durometer. Results from ANOVA showed the addition of ZnO at concentrations of 1%, 2%, and 4% did not statistically alter the silicon's hardness (P=0.48).

Elasticity, the ability of a material to revert to its original shape and size after deformation, is a fundamental characteristic of all materials. This property allows for the formulation of silicones with a broad spectrum of hardness levels, from soft and elastic to hard like ebonite, measured using the International Rubber Hardness or Shore gauges, which range from 0-100 degrees (Coombs, 1992). The optimal composition for a liner is determined through manufacturer testing, with standard acceptance tests including modulus and tensile testing. Modulus testing measures the stiffness of the silicone resin by determining the tensile stress needed to achieve a specific elongation, such as 300%. The relationship between hardness and modulus provides insight into the composites' stiffness. Table 2.2 and FIG. 2.7 show the average Young's Modulus for the prepared samples.

In the testing, the strain was limited to a maximum of 50% to ensure that the samples remained within the elastic deformation range (FIG. 2.7). This approach helped avoid any damage to the samples and prevented them from slipping out of the grips due to changes in volume while being clamped. At lower concentrations of 1% and 2%, ZnO did not significantly affect the silicone's stiffness, as indicated by the lack of statistical significance in the changes (P>0.96). At a 4% concentration, the addition of ZnO did lead to a small, yet statistically significant, increase in stiffness, as evidenced by a p-value of 0.02, indicating a less than 5% chance that this result is due to random variation. The Average Young's Modulus (32.17) at 4% weight fraction indicates a 2% increase in stiffness from the control, showing a real effect of ZnO on enhancing the material's rigidity at this concentration (FIG. 2.7).

In the present disclosure, data are provided pertaining to the development of the disclosed silicone resin composites by integrating platinum-cure silicone polymer (Smooth-Sil 950, Smooth-On, Inc., Macungie, PA, USA) with zinc oxide nanoparticles. The fabrication of these composite coupons utilized the disclosed technique that provides uniform distribution of zinc oxide particles within the composite matrix. The disclosed methods and compositions address an important aspect of composite material science: the precise positioning and concentration of additives to optimize material properties.

The mechanical properties of the disclosed composites, particularly their elastic moduli, were evaluated through uniaxial tensile testing and compared against various theoretical models cited in the literature. This comparison serves not only to validate the experimental approach but also to position the findings within the broader context of materials science research.

In various aspects, the present disclosure relates to the mechanical characterization of the fabricated composites by varying the zinc oxide content. By adjusting the concentration of zinc oxide, the disclosed data demonstrates the relationship of mechanical properties of the composites with varying zinc oxide amounts. The results disclosed herein demonstrate that the fabricated samples exhibited mechanical characteristics akin to those of conventional dairy milking liner materials as documented in existing literature, and the hardness and elasticity of the polymer matrix was not negatively impacted by the addition of ZnO particles at concentrations under 4% w/w.

Moreover, the data disclosed herein demonstrate that adding ZnO to the silicone does not appear to significantly change the hardness of the material at any of the tested concentrations (1%, 2%, and 4%). This is indicated by high p-values (p>0.92, p>0.18, and p>0.22), suggesting that any differences observed in hardness with these ZnO additions are likely due to random variation rather than a real effect of the ZnO. Similarly, adding 1% and 2% ZnO did not significantly affect the stiffness of the silicon, as the p-values are high (p>0.82 and p>0.64), indicating that the observed differences could easily be due to chance. However, at a 4% concentration, ZnO caused a slight but statistically significant increase in the stiffness (Young's Modulus) of the material, as indicated by a p-value of 0.01 (less than 0.05). The material became 2% stiffer, suggesting that the ZnO addition at this level has a real effect on increasing the stiffness of the silicon formulation. In summary, while the addition of ZnO up to 2% concentration didn't significantly impact the hardness or stiffness of the silicon material, a 4% concentration did make the material slightly stiffer, which is statistically significant and not likely due to chance.

The incorporation of zinc oxide into silicone resins provides an improved approach to enhancing the functionality and applicability of these materials in dairy industry applications. The ability to precisely control the positioning and amount of zinc oxide within the silicone matrix opens new avenues for localized optimization and performance enhancement of composite materials. The present disclosure pertains to the field of materials science generally, as well as specifically to the practical implications for the development of dairy equipment, where the antimicrobial properties and mechanical integrity of contact surfaces are of considered by users in the dairy industry to be importance.

TABLE 2.1
Average Shore A Hardness for various weight fractions
of zinc oxide in silicone polymer matrix

| | Average Shore A Hardness | |
|---|---|---|
| Weight Fraction % | (A) | SD |
| 0 | 48.59 | 1.33 |
| 1 | 48.52 | 1.98 |
| 2 | 47.73 | 1.44 |
| 4 | 47.99 | 0.73 |

TABLE 2.2
Average Young's Modulus for various weight fractions
of zinc oxide in silicone polymer matrix

| Weight Fraction % | Average Young's Modulus | SD |
|---|---|---|
| 0 | 31.44 | 0.47 |
| 1 | 31.48 (P = 0.99) | 1.98 |
| 2 | 31.55 (P = 0.95) | 1.44 |
| 4 | 32.17 (P = 0.02) | 0.73 |

### Example 2 References

1. Khaledi, A. A. R., Bahrani, M., & Shirzadi, S. (2015). Effect of food simulating agents on the hardness and bond strength of a silicone soft liner to a denture base acrylic resin. The Open Dentistry Journal.
2. Mein, G. A. (2012). The role of the milking machine in mastitis control. Veterinary Clinics: Food Animal Practice.
3. O'Shea, J., O'Callaghan, E., & Meaney, W. J. (1979). Relationship between machine milking and the incidence of mastitis in dairy cows. Irish Journal of Agricultural Research.
4. Prasad, S. (2023). A Review of Engineering Materials Used in the Dairy Processing Equipment. International Journal of Scientific Engineering and Research (IJSER), 11(3).
5. Azevedo, C., Pacheco, D., Soares, L., Romão, R., Moitoso, M., Maldonado, J., . . . & Simões, J. (2016). Prevalence of contagious and environmental mastitis-causing bacteria in bulk tank milk and its relationships with milking practices of dairy cattle herds in São Miguel Island (Azores). Tropical animal health and production, 48, 451-459.
6. Chen, D., Chen, F., Hu, X., Zhang, H., Yin, X., & Yao, K. (2015). Thermal stability, mechanical and optical properties of novel addition cured PDMS composites with nano-silica sol and MQ silicone resin. Composites Science and Technology.
7. Hurburgh, C. R., Paynter, L. N., Schmitt, S. G., & Bern, C. J. (1986). Measurements of effective teat load during machine milking. Transactions of the ASAE, 29(4), 1124-1130.
8. Hamann, J. (1991). Milking Hygiene, Milking. Dairy, Food and Environmental Sanitation, 11(5), 260-264.
9. Hamann, J., & Stanitzke, U. (1990). Studies on pathogenesis of bovine mastitis by comparison of milking conditions as calf suckling, hand milking and machine milking: reactions of the teat tissue. Milchwissenschaft, 45(10), 632-637.
10. Hatamleh, M. M., & Watts, D. C. (2010). Mechanical properties and bonding of maxillofacial silicone elastomers. Dental Materials.
11. Joseph, V. S., Calais, T., Stalin, T., Jain, S., & Sharma, A. (2021). Silicone/epoxy hybrid resins with tunable mechanical and interfacial properties for additive manufacture of soft robots. Applied Materials Today.
12. Kamonchaivanich, K., & Somwangthanaroj, A. (2003). The Gelation Behaviors and Mechanical Properties of Silicone Resins for A Breast Model Application. Journal of Metals, Materials and Minerals.
13. Kundapur, K., & Unnikrishnan, V. U. (2023). Effect of liquid inclusions on the elasto-mechanical properties of solid-liquid composites. Mechanics of Advanced Materials and Structures, 1-10.
14. Mein, G., Williams, D. M., & Reinemann, D. J. (2003 January). Effects of milking on teat-end hyperkeratosis: 1. Mechanical forces applied by the teatcup liner and responses of the teat. In annual meeting-national mastitis council incorporated (Vol. 42, pp. 114-123). National Mastitis Council; 1999.
15. Neijenhuis, F., Klungel, G. H., & Hogeveen, H. (2001). Recovery of cow teats after milking as determined by ultrasonographic scanning. Journal of Dairy Science, 84(12), 2599-2606.

### Example 3—Development and Analysis of Biofilm on Antimicrobial Polymers for the Dairy Industry

### Introduction

Mastitis in dairy cattle is the persistent inflammatory reaction of the udder tissue and is the most common disease among dairy cattle (Boireau et al., 2018). With direct and indirect costs of mastitis infections totaling $444 per animal (Rollin et al., 2015), it is also the costliest disease impacting the dairy industry. A primary duty of milking facilities is to control the prevalence of these organisms on surfaces shared between cows during milking operations-principally, the milking liners that pull milk from the bovine udders. Milking liners (dairy inflations, teat cup liners, or shell liners) are flexible, durable polymer inserts used by milking clusters to withdraw milk from the animal (FIG. 3.1). The liner transfers stimulation from the milking machine to the udder to induce lactation. The liner also carries produced milk from the teat into the milk supply line. These products are the only direct interface between the animal and the milking apparatus and are an important area for disease transmission prevention efforts (Rainard et al., 2018).

A significant challenge in the prevention, treatment, and study of biofilms lies in their inherent physiological heterogeneity. While individual cells can be isolated and analyzed from the biofilm, the spatial relationships, structure, and properties of the biofilm matrix are not maintained (Azeredo et al., 2017). It is, therefore, important to employ techniques that preserve these spatial relationships among cells when exploring biofilm formation and methods of degradation. The characteristics and physiology of bacterial cells within the biofilm can vary significantly based on their specific locations within the structure. This variability is not only vital for accurately investigating the biofilm, as techniques like-omic profiling may yield average results for a diverse biofilm population, but it also plays a pivotal role in the biofilm's resistance to preventive and treatment measures (Azeredo et al., 2017).

The main bacteria responsible for causing mastitis can be divided into contagious and environmental. Though the contagious strains of bacteria that cause mastitis are more virulent, both classifications of microorganisms are present on dairy milking liners. Both types of bacteria can contribute to mastitis infection. The collection of these organisms, along with their excretions and biological and non-biological matter, also contributes to the formation of a biofilm matrix on the milking liner surface (Michael et al., 2023).

In addition to transmitting pathogenic disease among animals, microbial prevalence on dairy liners contributes to inferior milk quality and further refined dairy products. A direct and quantifiable linkage exists between bacteria counts in raw milk and the final dairy product quality (Murphy et al., 2016). Conditions such as mastitis in the producing cows can introduce bacteria into the raw milk that is resistant to traditional antibiotics (methicillin-resistant strains) and current methods of pasteurization (spore-forming strains). Once bacteria are introduced into the milk and dairy equipment, the population can propagate rapidly—resulting in high somatic cell counts and increased bacteria plate counts within milk samples. These test results directly impact the ability of the dairy to market the product and can, therefore, lead to higher usage rates of antimicrobial drugs. Pasteurization has been the antidote for product-borne bacteria. However, specific types of spore-forming bacteria (i.e., Bacillus strains) can survive pasteurization and continue to grow and thrive in dairy products (Buehler et al., 2018). These bacteria, along with drug-resistant strains of microorganisms, are also demonstrative of pathogens that pose the most severe biological threat to the country's agriculture's security regarding water and milk supply. Decreasing the prevalence of microorganisms on dairy liner surfaces would directly reduce the number of colony-forming units that end up in the produced milk—thereby increasing the marketability and quality of dairy products and supporting responsible antimicrobial drug stewardship.

This project is important and timely because little work has been performed on preventing disease within dairies through microbial-resistant surfaces. Saied et al. (2011) is the first and only research study to the authors' knowledge examining silver particles in conjunction with mastitis. They present evidence for the rapid onset of antibacterial activity of silver particles in milk inoculated with Staphylococcus aureus and recommend using silver particles as an alternative to antibiotics in subclinical mastitis (Saied et al., 2011). For centuries, the non-toxic, effective antibacterial properties of silver have been documented and leveraged to control infection (Lansdown, 2006). However, little work has been done on creating polymer matrices embedded with inherently antimicrobial agents such as silver and others for use in livestock and veterinary settings. This gap in the research is especially glaring given the recent decisions by the US EPA recognizing copper surfaces as effective against disease-causing microorganisms, including multidrug-resistant strains of bacteria and, more recently, coronaviruses (U.S. EPA, 2021).

Researchers have explored various techniques for assessing and monitoring the development of biofilms, including the analysis of biofilm detachment dynamics under varying shear stress conditions through laser-based particle size assessment and mass fractionation. The measurement of biofilm thickness used a derivation of Arvin's (1991) methodology, where the increase in the sample's mass within the reactor correlates to an increase in the sample's biofilm mass. This volume, divided by the available surface area for biofilm growth, yields the average thickness of the biofilm.

The accumulation of organic material in the milking machines can foster conditions conducive to bacterial proliferation (Murphy & Boor, 2000) and facilitate bacterial adhesion through the formation of a conditioning film (Zottola & Sasahara, 1994). Such suboptimal temperatures hinder the effective removal of milk residues, as suggested by the National Mastitis Council (2018). Elevated Somatic Cell Count (SPC) and Preliminary Incubation Count (PIC) levels in the bulk tank milk (BTM) from this study could be attributed to inadequate cleaning practices of the milking equipment, as supported by findings from Murphy and Boor (2000) and Jayarao et al. (2004). The issue was likely exacerbated by scratches found on the milk meter surfaces, providing niches for bacterial attachment and biofilm formation.

The purpose of this study is to investigate the antimicrobial efficacy of platinum-cure silicone polymer, specifically Smooth-Sil 950, when embedded with zinc oxide (ZnO) and to evaluate the biofilm inhibitory characteristics of the ZnO imbued polymer. The research is devised to assist the dairy industry in addressing the issue of biofilm formation on milk contact surfaces and its role in the transmission of pathogenic diseases, such as mastitis. The polymer was selected for its ease of processing, commercial availability, and similarity to the physical properties of standard dairy liners. By designing a series of experiments involving the creation of silicone polymer samples with varying concentrations of ZnO and exposing these to unpasteurized dairy milk under controlled conditions, the study seeks to simulate real-world biofilm development and evaluate the antimicrobial effectiveness of the treated surfaces. This research endeavors to provide solutions that could help the dairy industry improve milk contact surface cleanliness, enhance milk quality, and reduce the prevalence of mastitis infections among dairy cows.

### Materials

For this research, a platinum-cure silicone polymer (Smooth-Sil 950) manufactured by Smooth-On, Inc. (Macungie, PA, USA) was chosen as the test material. It was selected due to its ease of processing, commercial availability, and similarity to the physical properties of proprietary polymers of many standard dairy liners. The antimicrobial test agent used in the study was zinc oxide (ZnO) provided by Buffalo Technology Group, Ltd in Dimmitt, Texas, USA.

A two-part silicone polymer was prepared at a 10:1 resin-to-hardener ratio, with ZnO added at 0, 1, 2, and 4% (wt/wt) concentrations. The mixture underwent a two-step blending process (1500 rpm, 2 minutes per step) using a planetary mixer (ARE 310, Thinky USA, Laguna Hills, CA, USA) to minimize agglomeration and preserve pot life.

An aluminum mold was manufactured and used according to Allen et al. (2024) to create molded plaques of silicon polymer with the same thickness (3 mm) as a common dairy liner (Pro-Square DPX CR, IBA Dairy Supplies, Sutton, MA, USA). The mold was positioned at a 45-degree angle to facilitate air evacuation, and the blended polymer was injected into the mold. After injection, the mold was placed in a pressure chamber at ambient temperature under 3.54 bar for 24 hours to reduce air pockets. Subsequently, the samples were released, washed, and cut into 50 mm×57 mm coupons for testing. The samples were then rewashed and allowed to air dry for 24 hours. Once dry, the samples were weighed using an electronic balance (ME 54E, Mettler-Toledo, LLC, Columbus, OH, USA).

### Proof of Concept Study

A preliminary test was designed to evaluate the feasibility of developing measurable amounts of biofilm from unpasteurized dairy milk on silicon samples in a short timeframe. A rotary test device was designed in Fusion 360 (Autodesk, Inc., San Francisco, CA, USA) and constructed from a 12.5 mm high-density polyethylene (HDPE) panel. The test device (FIG. 3.2) was loaded with four glass mason jars (Ball Company, USA). Each mason jar was filled with 205 g of unpasteurized milk harvested from bulk milk tanks (BTM) at the hospital milking parlor of a dairy in the Texas Panhandle. In each jar, one sample was suspended from the lid of the container using a 50 mm binder clip (spring steel retention clip). A neodymium magnet was positioned outside the jar lid to affix the binder clip to the top of the jar. The milk volume was selected to cover the sample completely when the jar was inverted and to expose the sample when the jar was upright. The jar assembly was loaded into the rotary device, and the magnet was located within the HDPE panel to ensure that the retention clip and sample assembly remained perpendicular to the axis of rotation. After 48 h, the samples and retention clips were withdrawn from the test rig and gently rinsed in distilled water to remove visible clumps. The assemblies were dried for 8 hours at 50° C. and then weighed.

### Secondary Testing

Based on results from the proof of concept test, a secondary test was devised to more closely mimic milk exposure and biofilm development in dairies. A custom tank with internal dimensions of 12.5 cm width×52 cm length×46 cm depth was designed to hold 11.3 L of milk. A new rotary test device (FIG. 3.3) was designed to hold the samples within a retention clip above the milk tank and allow them to rotate into and out of the milk. Both rotary test devices were powered by an alternating current electric motor and allowed to rotate at 1.8 revolutions per minute. Milk for the test was collected from bulk tank milk (BTM) of the hospital milking parlor at a Texas Panhandle diary. Before testing, the milk was plated using Peel Plate SA Plates to enumerate Staphylococcus aureus and total aerobic bacterial CFUs per ml.

Charm Peel Plates (Charm Sciences, Inc, Lawrence, MA, USA) are petri plates preloaded with a specialized medium that promotes aerobic bacteria growth by providing tryptone, yeast extract, and dextrose. The medium features agents that promote wicking of the inoculate and gelling, which allow the inoculate to be effectively absorbed and diffused through the growth medium. The medium is also equipped with an enzyme indicator known as TTC, which facilitates the identification of aerobic bacterial colonies by turning them red (Peel Plate AC). Peel Plate SAs were also used which identify colonies of Staphylococcus aureus by turning them purple and other bacterial colonies by turning them blue. This reaction occurs at either 32±1° C. for dairy products or 35±1° C. for food matrixes, with a duration of approximately 48±3 hours in test samples (Salter et al., 2016).

### Surface Swab Procedure

Cotton applicators with a wooden handle (Grand Rapids Industrial Products, Grand Rapids, MI, USA) measuring 20 mm long and 10 mm across at the widest point of the cotton sponge were sterilized by plunging into isopropyl alcohol for 5 minutes and allowing to air dry.

The 16 sponges were each placed, tip down, in a 100 ml beaker with 20 ml of Butterfield's Phosphate Buffered Dilution Water (BPBDW) (Weber Scientific, Hamilton, NJ, USA). As needed, the sponges were removed from the solution, and excess liquid was purged from the sponge by rolling it alongside the beaker wall. The leading face of each sample (FIGS. 3.4A-3.4B) was wiped using 8-10 streaks in one direction and 8-10 streaks perpendicular, rolling the sponge throughout the process. The sponge was then placed, sponge tip down, into a plastic bag containing 30 ml of BPBDW. The sponge was used to agitate the solution in the bag for 1 minute, and then all solution was squeezed from the tip.

One ml of solution was withdrawn from each bag and serially diluted using 15 ml conical centrifuge tubes (Membrane Solutions LLC, Auburn, WA, USA), each containing 9 ml BPBDW. Dilutions of 102 to 105 were plated in duplicate onto Charm Scientific Peel Plate AC plates according to manufacturer specifications. Plates were incubated for 48 hours at 32° C. per manufacturer specifications. Colonies were then counted to determine the CFU per ml of effluent. Data analysis was performed using R-Studio (Posit team, Boston, MA, USA).

### Mass Gain Measurements

After swab collection, the samples and spring steel hangers were unloaded from the rotary test rig and affixed to an aluminum extrusion beam with bar magnets (FIG. 3.5). The samples were placed in a convection oven and dried for 8 hours at 50° C. After drying, the samples were removed from the spring steel hangers and weighed using the same scale as prior.

### Results

Samples taken during the study indicate the presence of S. aureus in BTM from the hospital milking parlor at the test dairy (FIGS. 3.6A-3.6B). The presence of S. aureus in milk is indicative of an elevated risk of biofilm formation, consequently raising the likelihood of disease transmission among calves consuming such contaminated milk. Though the CFU's per mL of this observation (254) is less than the threshold Vargová et al. (2023) identified as likely to produce biofilm>5 Log₁₀ CFU per cm², environmental conditions in dairy operations, along with suboptimal CIP procedures and cleaning solution temperatures, could exacerbate biofilm formation, potentially leading to increased mastitis transmission. When these factors are combined with physical imperfections like scratches on milk meter surfaces, degradation of milking liners, and flow eddies within the milk transfer system, they could foster conditions conducive to bacterial growth and biofilm development.

Regarding the microbial growth data from swab testing, A Levene's Test indicated statistically equal variance (p=0.73), and Shapiro-Wilk Normality Tests showed normality for both the untrimmed (p=0.12) and trimmed (p=0.11) data (FIGS. 3.7A-3.7B). An independent samples t-test revealed no statistically significant difference in CFU for the trimmed (p=0.25) or untrimmed data (p=0.36). However, there is a numerical difference in data between the treatments that is supported by visual analysis of the samples before swabbing. This could indicate a lack of power within the experimental design or the presence of an unknown variable that is overshadowing the effects of the treatment. While the observed difference did not reach statistical significance at the alpha level of 0.05, its proximity and numerical distinction between the two treatments suggests a trend worthy of additional scrutiny and further experimentation.

Investigators were concerned about a lack of power in this experiment, hence why only one experimental treatment (4%) was tested. The variability associated with the milk composition and environmental factors make it difficult to design consecutive experiments to be analyzed compositely. The temperature of the non-climate-controlled test building also varied greatly with daily weather.

It was thought that the action of the paddle wheel moving through the milk would provide adequate mixing, but there was a striation effect that took place in the milk tank despite the paddle rotation. It may also be beneficial to include sanitization procedures periodically throughout the experiment to mimic CIP procedures at a dairy. It is of primary importance to design a more formal CIP procedure prior to swab testing. There was loose milk residue (chunks) on the surface of the samples prior to swabbing, even after the washing procedures were performed. These chunks undoubtedly increased the variability of the sample and were not demonstrative of biofilm development that was adhered to the surface of the samples. An iterative rinsing technique as described by Xue et al. (2014) could be put in place to provide a more thorough rinsing action—dislodging chunks while leaving true biofilm. Such a technique may more accurately depict the biofilm present on test surfaces.

### Conclusions

The operational mechanism of antimicrobial surfaces remains a subject of ongoing discussion, given the diverse chemical compositions and structural designs encountered, which precludes a unified theory of action. A notable challenge with cationic, contact-active antimicrobial surfaces is their propensity to attract proteins and debris from destroyed bacteria, attributed to their charged nature. This accumulation can deactivate the surface over time, allowing for the unchecked settlement and growth of new bacterial colonies on these deposits. Thus, the antimicrobial capabilities of these surfaces, though initially promising, may be compromised in long-term applications.

Reflecting on these findings, Riga et al. (2017) highlights the pursuit of alternative strategies aimed at enhancing the durability and effectiveness of antimicrobial polymer surfaces. These observations may explain the lack of difference between treatments but do not fully explain the mass loss observed in 10 of the 16 samples. This conundrum may be explained by an incomplete cure of the polymer samples before testing. Each sample was allowed to exceed the cure time specified by the manufacturer, but results indicate there may still have been off-gassing of volatile compounds occurring during the test. In future work, a heat-accelerated cure procedure, as described by Yap et al. (2024), could be applied to hasten the polymerization of the material and reduce mass loss associated with partially cured samples.

The present disclosure demonstrates the feasibility of using milk liners as a self-sanitizing interface between animals, milk, and machinery. The experimental approach as disclosed herein, involving the simulation of real-world conditions through the development of biofilm on silicone samples and subsequent antimicrobial testing, provides insights into designing surfaces that resist microbial colonization. This effort aligns with broader agricultural and public health objectives by aiming to enhance milk quality, reduce the reliance on antibiotics, and prevent the transmission of pathogenic bacteria among dairy calves—a concern highlighted by the practice of feeding calves with milk from infected animals.

### Example 3 References

1. Allen, B., Hunt, E., Richeson, J., Dodge, P., & Miersma, R. (2024). Polymeric materials enhanced with antimicrobial additives for use in dairy milking applications. International Journal of Agriculture and Technology, 4(1), 1-6.
2. Arvin, E. (1991). Biodegradation kinetics of chlorinated aliphatic hydrocarbons with methane oxidizing bacteria in an aerobic fixed biofilm reactor. Water Research, 25(7), 873-881.
3. Azeredo, J., Azevedo, N. F., Briandet, R., Cerca, N., Coenye, T., Costa, A. R., Desvaux, M., Di Bonaventura, G., Hébraud, M., Jaglic, Z., Kačániová, M., Knøchel, S., Lourenço, A., Mergulhão, F., Meyer, R. L., Nychas, G., Simões, M., Tresse, O., & Sternberg, C. (2017). Critical review on biofilm methods. Critical Reviews in Microbiology, 43(3), 313-351. https://doi.org/10.1080/1040841x.2016.1208146
4. Boireau, C., Cazeau, G., Jarrige, N., Calavas, D., Madec, J.-Y., Leblond, A., Haenni, M., & Gay, É. (2018). Antimicrobial resistance in bacteria isolated from mastitis in dairy cattle in France, 2006-2016. Journal of Dairy Science, 101(10), 9451-9462. https://doi.org/10.3168/jds.2018-14835
5. Buehler, A. J., Martin, N. H., Boor, K. J., & Wiedmann, M. (2018). Psychrotolerant spore-former growth characterization for the development of a dairy spoilage predictive model. Journal of dairy science, 101(8), 6964-6981.
6. Jayarao, B. M., Pillai, S. R., Sawant, A. A., Wolfgang, D. R., & Hegde, N. V. (2004). Guidelines for monitoring bulk tank milk somatic cell and bacterial counts. Journal of dairy science, 87(10), 3561-3573.
7. Lansdown, A. B. (2006). Silver in health care: antimicrobial effects and safety in use. Biofunctional textiles and the skin, 33, 17-34.
8. Michael, C. K., Lianou, D. T., Tsilipounidaki, K., Gougoulis, D. A., Giannoulis, T., Vasileiou, N. G. C., Mavrogianni, V. S., Petinaki, E., & Fthenakis, G. C. (2023). Recovery of Staphylococci from Teatcups in Milking Parlours in Goat Herds in Greece: Prevalence, Identification, Biofilm Formation, Patterns of Antibiotic Susceptibility, Predictors for Isolation. Antibiotics, 12(9), 1428. https://doi.org/10.3390/antibiotics12091428
9. Murphy, S. C., & Boor, K. J. (2000). Trouble-shooting sources and causes of high bacteria counts in raw milk.
10. Murphy, S. C., Martin, N. H., Barbano, D. M., & Wiedmann, M. (2016). Influence of raw milk quality on processed dairy products: How do raw milk quality test results relate to product quality and yield?. Journal of Dairy Science, 99(12), 10128-10149.
11. National Mastitis Council (NMC). (2018). “10-point mastitis control plan.” NMC. https://www.nmconline.org/wp-content/uploads/2020/04/recommended-mastitis-control-program.pdf
12. Rainard, P., Foucras, G., Fitzgerald, J. R., Watts, J. L., Koop, G., & Middleton, J. R. (2018). Knowledge gaps and research priorities in Staphylococcus aureus mastitis control. Transboundary and Emerging Diseases, 65, 149-165. https://doi.org/10.1111/tbed.12698
13. Riga, E. K., Vöhringer, M., Widyaya, V. T., & Lienkamp, K. (2017). Polymer-Based Surfaces Designed to Reduce Biofilm Formation: From Antimicrobial Polymers to Strategies for Long-Term Applications. Macromolecular Rapid Communications, 38(20). https://doi.org/10.1002/marc.201700216
14. Rollin, E., Dhuyvetter, K. C., & Overton, M. W. (2015). The cost of clinical mastitis in the first 30 days of lactation: An economic modeling tool. Preventive Veterinary Medicine, 122(3), 257-264. https://doi.org/10.1016/j.prevetmed.2015.11.006
15. Saied, H. D., Fatemeh, H., & Azizollah, E. K. (2011). An in vitro evaluation of antibacterial effect of silver nanoparticles on Staphylococcus aureus isolated from bovine subclinical mastitis. African Journal of Biotechnology, 10(52), 10795-10797. https://doi.org/10.5897/ajb11.1499
16. Salter, R. S., Durbin, G. W., Bird, P., Fisher, K., Crowley, E., Hammack, T., Chen, Y., Clark, D., & Ziemer, W. (2016). Validation of the Peel Plate™ AC for Detection of Total Aerobic Bacteria in Dairy and Nondairy Products. Journal of AOAC INTERNATIONAL, 99(1), 143-152. https://doi.org/10.5740/jaoacint.15-0253
17. Schalm, O. W. (1942). Streptococcus agalactiae in the udders of heifers at parturition traced to sucking among calves.
18. Selim, S. A., & Cullor, J. S. (1997). Number of viable bacteria and presumptive antibiotic residues in milk fed to calves on commercial dairies. Journal of the American Veterinary Medical Association, 211(8), 1029-1035.
19. U.S. Environmental Protection Agency. (2021). EPA registers copper surfaces for residual use against coronavirus. U.S. EPA Office of Chemical Safety and Pollution Prevention, 2. Available from: https://www.epa.gov/newsreleases/epa-registers-copper-surfaces-residual-use-against-coronavirus
20. Vargová, M., Zigo, F., Výrostková, J., Farkašová, Z., & Rehan, I. F. (2023). Biofilm-Producing Ability of Staphylococcus aureus Obtained from Surfaces and Milk of Mastitic Cows. Veterinary Sciences, 10(6), 386. https://doi.org/10.3390/vetsci10060386
21. Xue, Z., Lu, H., & Liu, W.-T. (2014). Membrane biofouling characterization: effects of sample preparation procedures on biofilm structure and the microbial community. Biofouling, 30(7), 813-821. https://doi.org/10.1080/08927014.2014.935937
22. Yap, T. F., Rajappan, A., Bell, M. D., Rasheed, R. M., Decker, C. J., & Preston, D. J. (2024). Thermally accelerated curing of platinum-catalyzed elastomers. Cell Reports Physical Science, 5(3).
23. Zottola, E. A., & Sasahara, K. C. (1994). Microbial biofilms in the food processing industry-should they be a concern?. International journal of food microbiology, 23(2), 125-148.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

It should be emphasized that the above-described embodiments of the present disclosure are merely possible examples of implementations and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

The above examples are put forth so as to provide those of ordinary skill in the art with a complete disclosure and description of how to perform the methods and use the imaging agents disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

What is claimed is:

1. An antimicrobial composition for molded products, comprising an antimicrobial agent embedded in a silicone polymer matrix,
wherein the antimicrobial agent comprises: zinc oxide, titanium dioxide, silver, or combinations thereof;
wherein the antimicrobial agent comprises about 1% to about 4% of the composition by weight; and
wherein the antimicrobial agent is uniformly distributed in the silicone polymer matrix.

2. The composition of claim 1, wherein the silicone polymer matrix is an addition-cure silicone polymer.

3. The composition of claim 1, wherein the antimicrobial agent is zinc oxide.

4. The composition of claim 3, wherein the zinc oxide comprises about 4% of the composition by weight.

5. A method for manufacturing an antimicrobial molded product, comprising:
a) mixing an antimicrobial agent and a silicone polymer to form a composite,
wherein the antimicrobial agent comprises: zinc oxide, titanium dioxide, silver, or combinations thereof,
wherein the antimicrobial agent comprises about 1% to about 4% of the composite by weight, and
wherein the antimicrobial agent is uniformly distributed in the silicone polymer;
b) injecting the composite into a mold such that the composite fills a cavity of the mold;
c) curing the composite such that the composite solidifies; and
d) releasing the composite from the mold.

6. The method of claim 5, wherein the antimicrobial agent and the silicone polymer are mixed at least twice for a period of time before injection into the mold.

7. The method of claim 5, wherein the composite is cured under a pressure of about 50 psi.

8. The method of claim 5, wherein the composite is injected into the mold using a catheter tip syringe.

9. The method of claim 5, wherein the silicone polymer is an addition-cure silicone polymer comprising a resin and a hardener.

10. The method of claim 9, wherein mixing the antimicrobial agent and the silicone polymer to form the composite further comprises:
adding the antimicrobial agent to the resin and mixing for a first period of time; and
adding the hardener to the resin and the antimicrobial agent to form the composite, wherein the composite is mixed for a second period of time.

11. The method of claim 5, wherein the antimicrobial agent is zinc oxide.

12. The method of claim 11, wherein the zinc oxide comprises about 4% of the composite by weight.

13. An antimicrobial milking liner made from a composition comprising an antimicrobial agent embedded in a silicone polymer matrix,
wherein the antimicrobial agent comprises: zinc oxide, titanium dioxide, silver, or combinations thereof,
wherein the antimicrobial agent comprises about 1% to 4% of the composition by weight, and
wherein the antimicrobial agent is uniformly distributed in the silicone polymer matrix.

14. The antimicrobial milking liner of claim 13, wherein the antimicrobial agent is zinc oxide.

15. The antimicrobial milking liner of claim 14, wherein the zinc oxide comprises about 4% of the composite by weight.

16. The antimicrobial milking liner of claim 13, wherein the antimicrobial milking liner has a thickness of about 3 mm.

17. A method of abrogating or eliminating mastitis in a dairy herd comprising using an antimicrobial milking liner made from a composite comprising an antimicrobial agent embedded in a silicone polymer matrix,
wherein the antimicrobial agent comprises: zinc oxide, titanium dioxide, silver, or combinations thereof,
wherein the antimicrobial agent comprises about 1% to about 4% of the composition by weight, and
wherein the antimicrobial agent is uniformly distributed in the silicone polymer matrix.

18. The method of claim 17, wherein the silicone polymer matrix is an addition-cure silicone polymer.

19. The method of claim 17, wherein the antimicrobial agent is zinc oxide.

20. The method of claim 19, wherein the zinc oxide comprises about 4% of the composite by weight.
